(19) United States
(12) Patent Application Publication
(10) Pub. No.: US 2009/0054089 A1
(43) Pub. Date: Feb. 26, 2009

(54) COMMUNICATION TERMINAL, SECURE DEVICE, AND INTERGRATED CIRCUIT

(75) Inventors: Emi Tsurukiri, Tokyo (JP); Hisashi Takayama, Tokyo (JP); Hayashi Ito, Chiba (JP); Masamoto Tanabiki, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/914,150

(22) PCT Filed: May 2, 2006
(86) PCT No.: PCT/JP2006/309146

§ 371 Date: Nov. 12, 2007

(30) Foreign Application Priority Data
May 13, 2005 (JP) 2005-141486

(51) Int. Cl. H04W 8/00

(52) U.S. Cl. 455/466

(57) ABSTRACT

The present invention has an object to provide a communication terminal, a secure device, and an integrated circuit, by which before data is transmitted by a transmission-sided communication terminal, a security process operation is carried out under environment of a communication terminal having a possibility of using the data with respect to threats caused by computer viruses and the like, which are operated in an illegal manner and are operable in correspondence with various sorts of platforms, and thus, safety characteristics with respect to the data can be assured.

When a portable telephone 101 transmits data, a data analyzing unit 113 extracts identification information of a communication counter terminal 103 described in transmission data, and selects a predetermined verifying operation in response to an environment of the communication counter terminal 103 by referring to a permission information database 114. The selected security process operation is carried out by a data verifying unit 116, and the transmission data is notified to the communication counter terminal 103 in combination with security process information.

### TECHNICAL FIELD

The present invention is related to a communication terminal for transmitting data to a communication counter terminal and a secure device such as an IC card that is connected to the communication terminal so as to be utilized. More specifically, the present invention is directed to a communication terminal, a secure device, and an integrated circuit, in which verification operation of transmission data is carried out in response to an execution environment of a communication counter terminal on the transmission side.

### BACKGROUND ART

Very recently, since the Internet has been popularized, various sorts and various modes of services are available, so that convenient opportunities are improved, and on the other hand, disturbances and criminal acts using networks are rapidly increased. Current reports have announced that damages caused by virus infections and information leakages largely occur. In coming ubiquitous network ages, while portable appliances and household appliances are connected to networks, many sorts of information resources are transmitted/received on the networks and these information resources are managed and utilized as electronic information. Under such a circumstance, social recognitions with respect to important characteristics for securing safety and reliable characteristics of information communication networks are quickly increased.

In order to realize securities as to information communication networks, the following methods own merits, namely, information flowing over networks is monitored and encrypted; verification for judging that who is an access person is performed; virus checks and packet filtering are carried out; and invasion detecting systems are conducted. These security devices are mounted on gateways, servers, and communication terminals in accordance with use fields. Moreover, security degrees may be considerably increased, since users are forced to obey information security policies, while these information security policies contain measures and rules to be taken so as to protect information resources.

FIG. 17 is a block diagram for schematically showing an arrangement of a security system of a conventional information communication network using the Internet. A company LAN 102 holding a communication terminal 1001 contains a server apparatus group 1003, and a gateway 1005 that relays an access to a communication network 1004. An external client terminal 1006 accesses via the gateway 1005 to the server apparatus group 1003. In such a system, most of security functions capable of realizing the above-explained information communication network securities are provided in both the server apparatus group 1003 and the gateway 1005.

As means of emphasizing securities with respect to communications established between the communication terminal 1001 and the external client terminal 1006, the below-mentioned electronic mail information managing method has been proposed (refer to, for instance, patent publication 1). That is, in an electronic mail server employed in the above-described server apparatus group 1003, the electronic mail information managing method analyzes electronic mail information when an electronic mail to be transmitted, or received is either transmitted or received so as to detect an item which constitutes electronic mail information; the managing method performs a predetermined security check process operation in response to this detected item in order to check as to whether or not a computer virus is present, and also to judge as to whether or not this electronic mail information should be distributed to a mail receiver.

FIG. 18 is a diagram for representing an entire arrangement of the above-described electronic mail information management system.

When electronic mail software 1102 of a user terminal 1100 is initiated and then an electronic mail is transmitted via a transmitting unit 1101 to an electronic mail server 1103, an electronic mail information analyzing unit 1104 analyzes electronic mail information so as to extract necessary information from the electronic mail information, and then, saves the extracted necessary information in a database unit 1105. Thereafter, the electronic mail information analyzing unit 1104 performs a predetermined process operation, and judges as to whether or not it is proper to distribute the analyzed electronic mail to a mail receiver. As a result, the process operation for properly exterminating computer viruses, and the checking operation for checking the contents of the electronic mail information, and further, the process operation for processing this content check, which should be properly performed by the mail receiver, can be automatically carried out on the side of the electronic mail information management system at a stage before the electronic mail information is delivered to the mail receiver.
Patent publication 1: JP-A-11-252158 (pages 5 to 6)

### DISCLOSURE OF THE INVENTION

### Problems that the Invention is to Solve

However, in the above-explained conventional managing system arrangement, when a P2P (Pear to Peer) communication is performed by which information is transmitted and received between the communication terminal 101 and the external client terminal 1006, and a security process operation has been performed by encrypting information itself, even if strong security functions are provided on the gateway 1005 and the server apparatus group 1003, the security check cannot be carried out with respect to the contents of the encrypted information. As a consequence, sufficient security checking operation can be hardly performed.

Moreover, in such a case that the communication terminal 1001 is communicated with the external client terminal 1006, this communication operation is not always performed via the server apparatus group 1003 employed in the company LAN 1002. For instance, there are some cases that the communication terminal 1001 is communicated with the external client terminal 1006 via an external server, for example, by utilizing a data communication function of a portable telephone. At this time, reliability as to the security function of the utilized external server cannot be firmly guaranteed. As a result, the safety characteristic of the information cannot be sufficiently guaranteed with respect to the external client terminal 1006.

While threats of computer viruses operated on the major OS presently cause problems, there are many possibilities that various types of computer viruses operable on various sorts of platforms will occur in future. In this case, even if transmission data can pass security checks adapted to the major OS in the server apparatus group 1003 and the gateway 1005, the following problem is conceivable. That is, such a program which may cause failures in the external client terminal 1006 due to differences in execution environments on the external client terminal 1006 on which the different OS from the major OS is installed. On the other hand, it is practically difficult to execute all of security check process operations adapted to various sorts of environments. The larger an information amount of data which should be processed in security checks is increased, the longer the processing time is prolonged. Accordingly, this checking method never constitutes a realistic solving method.

The present invention has been made to solve the above-described conventional problems, and therefore, has an object to provide a communication terminal, a secure device, and an integrated circuit, which are operable in such a manner that when a security apparatus provided on a server, or a gateway is not valid in such as P2P communications and the like between communication terminals, a security check function having a higher efficiency in correspondence with environments of communication destinations is realized on a communication terminal so as to emphasize a security with respect to information transfers, so that transmissions of illegal information can be prevented.

### Means for Solving the Problems

A communication terminal of the present invention is featured by such a communication terminal for transmitting data to a communication counter terminal via a network connected thereto, which is capable of transferring information, comprising: a data analyzing unit for extracting identification information which identifies a communication counter terminal described in data which is transmitted, and for determining a predetermined verifying operation with respect to the data based upon the identification information in response to an execution environment of the communication counter terminal; and a data verifying unit for executing the verifying operation determined by the data analyzing unit.

With employment of the above-explained arrangement, security verification can be realized on the transmission side in response to the execution environment of the communication counter terminal.

Also, the communication terminal of the present invention is featured by employing such an arrangement that the data analyzing unit is comprised of: a permission information database which has described therein execution environmental information of the communication counter terminal and a verifying operation executed by the data verifying unit in correspondence with the identification information; and the data analyzing unit determines the verifying operation based upon the identification information by referring to the permission information database.

With employment of the above-explained arrangement, the data analyzing unit can readily specify the execution environmental information of the communication counter terminal based upon the identification information by referring to the permission information database, and can determine the predetermined verifying operation in response to the execution environment.

Also, the communication terminal of the present invention is featured by employing such an arrangement that a verifying operation which is executed by said data verifying unit is further described in the permission information database in correspondence with a sort of data to be transmitted; and the data analyzing unit determines a necessary verifying operation based upon the identification information and the sort of the data by referring to the permission information database.

With employment of the above-explained arrangement, the verifying operation is further selected based upon the sort of data, and thus, the verifying operation that is performed in the transmission-sided terminal can be focused on the necessary verifying operation.

Also, the communication terminal of the present invention is featured by employing such an arrangement that the data analyzing unit is further comprised of: a permission information database updating unit; and wherein: the permission information database updating unit updates the permission information database based upon data received from the communication counter terminal.

With employment of the above-described arrangement, as to the identification information, the execution environment information, and the sort of the executable data of the communication counter terminal, the latest information thereof can be acquired by the communication counter terminal, so as to update the permission information database.

Also, the communication terminal of the present invention is featured by employing such an arrangement that in the case that an execution environment of the communication counter terminal has been recorded in the permission information database, the permission information database updating unit compares execution environmental information of the communication counter terminal which is specified from the data received from the communication counter terminal with execution environmental information which has already been recorded in the permission information database; when the execution environmental information of the communication counter terminal is not coincident with the recorded execution environmental information, the permission information database updating unit updates the execution environmental information recorded in the permission information database by the execution environmental information of the communication counter terminal which is acquired from the data received from the communication counter terminal.

With employment of the above-explained arrangement, even when the execution environment of the communication counter terminal is changed due to a version-up operation and a purchase of a new terminal, the communication terminal can be operated in response to the change of the communication counter terminal.

Also, the communication terminal of the present invention is featured by employing such an arrangement that in the case that the execution environmental information of the communication counter terminal is not described in the permission information database, the permission information database updating unit newly records the execution environmental information of the communication counter terminal which is specified from the data received from the communication counter terminal in the permission information database.

With employment of the above-explained arrangement, when the identification information and the execution environment information of the communication counter terminal have not been registered, the execution environmental information of the communication counter terminal can be acquired from the reception data so as to be newly registered in the permission information database, and thus, the predetermined verifying operation can be easily carried out in response to the execution environmental information of the communication counter terminal.

A secure device of the present invention is featured by such a secure device connectable with a communication terminal for transmitting data to a communication counter terminal via a network connected thereto, which is capable of transferring information, comprising: a data analyzing unit for acquiring transmission data before being transmitted from the communication terminal, for extracting identification information which identifies the communication counter terminal described in the transmission data, and for determining a predetermined verifying operation with respect to the data based upon the identification information in response to an execution environment of the communication counter terminal; and a data verifying unit for executing the verifying operation determined by the data analyzing unit.

With employment of the above-explained arrangement, security verification can be realized on the transmission side in response to the execution environment of the communication counter terminal. In a plurality of terminals on which the secure device can be mounted, the predetermined verifying operations can be uniformly carried out.

Also, the secure device of the present invention is featured by employing such an arrangement that the data analyzing unit is further comprised of: a permission information database which has described therein execution environmental information of the communication counter terminal and a verifying operation executed by the data verifying unit in correspondence with the identification information; and the data analyzing unit determines the verifying operation based upon the identification information by referring to the permission information database.

With employment of the above-explained arrangement, the data analyzing unit can readily specify the execution environmental information of the communication counter terminal based upon the identification information by referring to the permission information database, and can determine the predetermined verifying operation in response to the execution environment.

Also, the secure device of the present invention is featured by employing such an arrangement that a verifying operation which is executed by the data verifying unit is further described in the permission information database in correspondence with a sort of data which is transmitted by the communication terminal; and the data analyzing unit determines a necessary verifying operation based upon the identification information and the sort of the data by referring to the permission information database.

With employment of the above-explained arrangement, the verifying operation is further selected based upon the sort of data, and thus, the verifying operation which is performed in the secure device can be focused on the necessary verifying operation.

Also, the secure device of the present invention is featured by employing such an arrangement that the data analyzing unit is further comprised of: a permission information database updating unit; and wherein: the permission information database updating unit updates the permission information database based upon data received from the communication counter terminal by the communication terminal.

With employment of the above-described arrangement, as to the identification information, the execution environment information, and the sort of the executable data of the communication counter terminal, the latest information thereof can be acquired by the communication counter terminal so as to update the permission information database.

Also, the secure device of the present invention is featured by employing such an arrangement that in the case that an execution environment of the communication counter terminal has been recorded in the permission information database, the permission information database updating unit compares execution environmental information of the communication counter terminal which is specified from the data received from the communication counter terminal by the communication terminal with execution environmental information which has already been recorded in the permission information database; when the execution environmental information of the communication counter terminal is not coincident with the recorded execution environmental information, the permission information database updating unit updates the execution environmental information recorded in the permission information database by the execution environmental information of the communication counter terminal which is acquired from the data received from the communication counter terminal.

With employment of the above-explained arrangement, even when the execution environment of the communication counter terminal is changed due to a version-up operation and a purchase of a new terminal, the communication terminal can be operated in response to the change of the communication counter terminal.

Also, the secure device of the present invention is featured by employing such an arrangement that in the case that the execution environmental information of the communication counter terminal is not described in the permission information database, the permission information database updating unit newly records the execution environmental information of the communication counter terminal which is specified from the data received from the communication counter terminal in the permission information database.

With employment of the above-explained arrangement, when the identification information and the execution environment information of the communication counter terminal have not been registered in the permission information database, the execution environmental information of the communication counter terminal is acquired from the reception data so as to be newly registered in the permission information database, and thus, the predetermined verifying operation can be easily carried out in response to the execution environmental information of the communication counter terminal.

A communication terminal of the present invention is featured by such a communication terminal on which the above-explained secure device can be mounted, comprising: a device processing unit for judging as to whether or not the secure device is mounted; and an information processing unit operated in such a manner that when the device processing unit judges that the secure device is mounted, before data is transmitted from the communication terminal, the information processing unit transmits the data to the secure device.

With employment of the above-explained arrangement, it is possible to grasp as to whether or not the secure device is mounted on the communication terminal. When it is so judged that the secure device is mounted, a predetermined verifying operation can be carried out before the data is transmitted from the communication terminal.

Also, a communication terminal of the present invention is featured by such a communication terminal for transmitting data with respect to a secure device mounted on the communication terminal, comprising: a device processing unit for acquiring identification information from the secure device when the secure device is mounted, the identification information identifying a owner of the secure device; a data analyzing unit for determining a predetermined verifying operation with respect to the data based upon the identification information in response to an execution environment of an appliance where the secure device is used; and a data verifying unit for executing the verifying operation determined by the data analyzing unit.

With employment of the above-explained arrangement, since the device processing unit refers to the permission information database, the device processing unit can specify the owner of the secure device and can specify the information of the execution environment owned by the owner. Also, the security verification in response to the execution environment of the communication terminal owned by the owner of the secure device can be realized in the communication terminal on the transmission side.

Also, the communication terminal of the present invention is featured by employing such an arrangement that the data analyzing unit is comprised of: a permission information database which has described therein execution environmental information of the appliance where the secure device is utilized and a verifying operation executed by the data verifying unit in correspondence with the identification information; and the data analyzing unit determines the verifying operation based upon the identification information by referring to the permission information database.

With employment of the above-explained arrangement, the data analyzing unit refers to the permission information database based upon the identification information, and can easily specify the execution environmental information of the appliance where the secure device is utilized, and also can determine the predetermined verifying operation.

Also, the communication terminal of the present invention is featured by employing such an arrangement that a verifying operation which is executed by the data verifying unit is further described in the permission information database in correspondence with a sort of data which is transmitted by the communication terminal; and the data analyzing unit determines a necessary verifying operation based upon the identification information and the sort of the data by referring to the permission information database.

With employment of the above-explained arrangement, the verifying operation is further selected based upon the sort of data, and thus, the verifying operation which is performed in the secure device can be focused on the necessary verifying operation.

Also, the communication terminal of the present invention is featured by employing such an arrangement that when data is transmitted to the secure device, the data analyzing unit further determines a predetermined verifying operation based upon the identification information in response to an execution environment of the secure device; and the data verifying unit executes the verifying operation determined by the data analyzing unit.

With employment of the above-described arrangement, not only operations of the transmission data on the appliance where the secure device is utilized can be verified, but also operations of the transmission data when being used in the secure device can be verified.

A secure device of the present invention is featured by such a secure device which is connected to a first terminal so as to write thereinto data, and connected to a second terminal so as to read the data, whereby the secure device transmits and receives data between the first and second terminals, comprising: a memory unit for storing thereinto the data; a data analyzing unit for determining a predetermined verifying operation with respect to the data in response to an execution environment of the second terminal; and a data verifying unit for executing the verifying operation determined by the data analyzing unit; wherein: before the data received from the first terminal is stored in the memory unit, the data analyzing unit determines the verifying operation, and the data verifying unit verifies the data.

With employment of the above-explained arrangement, before the data received from the first terminal is stored in the memory unit, the security verification in response to the execution environment of the second terminal can be realized. In a plurality of terminals on which the secure device can be mounted, the predetermined verifying operations can be uniformly carried out.

Also, the secure device of the present invention is featured by employing such an arrangement that the data analyzing unit is comprised of: a permission information database which has described therein a verifying operation executed by the data verifying unit in correspondence with identification information of a terminal; and the data analyzing unit determines the verifying operation based upon the identification information of the second terminal by referring to the permission information database.

With employment of the above-explained arrangement, the data analyzing unit refers to the permission information database based upon the identification information of the second terminal, and can readily specify the execution environmental information of the second terminal, and also can determine the predetermined verifying operation in response to the execution environment before the data received from the first terminal is stored in the memory unit.

Also, the secure device of the present invention is featured by employing such an arrangement that a verifying operation which is executed by the data verifying unit is further described in the permission information database in correspondence with a sort of data which is transmitted by the communication terminal; and the data analyzing unit determines a necessary verifying operation based upon the identification information and the sort of the data by referring to the permission information database.

With employment of the above-explained arrangement, the verifying operation is further selected based upon the sort of data, and thus, the verifying operation which is performed in the secure device can be focused on the necessary verifying operation.

Also, a secure device of the present invention is featured by such a secure device which is connected to a first terminal so as to write thereinto data, and connected to a second terminal so as to read the data, whereby the secure device transmits and receives data between the first and second terminals, comprising: a memory unit for storing thereinto the data; a data analyzing unit for determining a predetermined verifying operation with respect to the data in response to an execution environment of the second terminal; and a data verifying unit for executing the verifying operation determined by the data analyzing unit; wherein: before the data stored in the memory unit is transmitted to the second terminal during reading operation, the data analyzing unit determines the verifying operation, and the data verifying unit verifies the data.

With employment of the above-described arrangement, when the data is read, the security verifying operation can be realized in response to the execution environment of the second terminal before the data stored in the memory unit is transmitted to the second terminal. In a plurality of terminals on which the secure device can be mounted, the predetermined verifying operations can be uniformly carried out.

Also, the secure device of the present invention is featured by employing such an arrangement that the data analyzing unit is comprised of: a permission information database which has described therein a verifying operation executed by the data verifying unit in correspondence with identification information of a terminal; and the data analyzing unit determines the verifying operation based upon the identification information of the second terminal by referring to the permission information database.

With employment of the above-explained arrangement, the data analyzing unit refers to the permission information database based upon the identification information of the second terminal, and can readily specify the execution environmental information of the second terminal, and also can determine the predetermined verifying operation in response to the execution environment before the data stored in the memory unit is transmitted to the second terminal.

Also, the secure device of the present invention is featured by employing such an arrangement that a verifying operation which is executed by the data verifying unit is further described in the permission information database in correspondence with a sort of data which is transmitted by the communication terminal; and the data analyzing unit determines a necessary verifying operation based upon the identification information and the sort of the data by referring to the permission information database.

With employment of the above-explained arrangement, the verifying operation is further selected based upon the sort of data, and thus, the verifying operation which is performed in the secure device can be focused on the necessary verifying operation.

An integrated circuit of the present invention is featured by such an integrated circuit of a communication terminal, comprising: a data analyzing unit for extracting identification information which identifies a communication counter terminal described in data which is transmitted by the communication terminal, and for determining a predetermined verifying operation with respect to the data based upon the identification information in response to an execution environment of the communication counter terminal; and a data verifying unit for executing the verifying operation determined by the data analyzing unit.

With employment of the above-explained arrangement, security verification can be realized on the transmission side in response to the execution environment of the communication counter terminal.

Also, the integrated circuit of the present invention is featured by employing such an arrangement that the data analyzing unit is comprised of: a permission information database which has described therein execution environmental information of the communication counter terminal and a verifying operation executed by the data verifying unit in correspondence with the identification information; and the data analyzing unit determines the verifying operation based upon the identification information by referring to the permission information database.

With employment of the above-explained arrangement, the data analyzing unit can readily specify the execution environmental information of the communication counter terminal based upon the identification information by referring to the permission information database, and can determine the predetermined verifying operation in response to the execution environment.

Also, the integrated circuit of the present invention is featured by employing such an arrangement that a verifying operation which is executed by the data verifying unit is further described in the permission information database in correspondence with a sort of data which is transmitted by the communication terminal; and the data analyzing unit determines a necessary verifying operation based upon said identification information and the sort of the data by referring to the permission information database.

With employment of the above-explained arrangement, the verifying operation is further selected based upon the sort of data, and thus, the verifying operation which is performed in the integrated circuit can be focused on the necessary verifying operation.

### ADVANTAGE OF THE INVENTION

The present invention can provide the communication terminal, the secure device, and the integrated circuit, which own the following advantages. That is, in the case that a security apparatus provided on a server, or a gateway is not valid in such as P2P communications and the like between communication terminals, the security check function having the higher efficiency in correspondence with the environments of the communication destinations is realized on the communication terminal so as to emphasize the security with respect to the information transfers, so that the transmission of the illegal information can be prevented.

### BRIEF DESCRIPTION OF THE DRAWINGS

FIG. 1 is a block diagram for showing an entire system of an information transfer control apparatus according to an embodiment mode 1 of the present invention.

FIG. 2 is a block diagram for indicating an entire system of an information transfer control apparatus according to an embodiment mode 2 of the present invention.

FIG. 3 is a block diagram for showing an entire system of an information transfer control apparatus according to an embodiment mode 3 of the present invention.

FIG. 4 is a block diagram for indicating another entire system of an information transfer control apparatus according to the embodiment mode 3 of the present invention.

FIG. 5 is a flow chart for describing operations of the information transmission control apparatus according to the embodiment mode 1 of the present invention.

FIG. 6 is a diagram for showing a general structure of electronic mail data.

FIG. 7 is a diagram for indicating an example of a permission information data table in the embodiment mode 1 of the present invention.

FIG. 8 is a diagram for schematically showing a security process list formed in correspondence with environmental information in the embodiment mode 1 of the present invention.

FIG. 9 is a diagram for representing an example of a data structure of security process information in the embodiment mode 1 of the present invention.

FIG. 10 is a diagram for indicating an example as to security process information attached to transmission data in the embodiment mode 1 of the present invention.

FIG. 11 is a flow chart for describing updating operations of a permission information database in the embodiment mode 1 of the present invention.

FIG. 12 is a diagram for representing a general structure of a header portion of electronic mail data.

FIG. 13 is a flow chart for showing operations of transmitting data to a memory card in the embodiment mode 1 of the present invention.

FIG. 14 is a flow chart for describing operations of the information transfer control apparatus in the embodiment mode 2 of the present invention.

FIG. 15 is a flow chart for describing operations of the information transfer control apparatus in the embodiment mode 3 of the present invention.

FIG. 16 is a flow chart for describing operations of the information transfer control apparatus in the embodiment mode 4 of the present invention.

FIG. 17 is a structural diagram for indicating the security system of the conventional information communication network.

FIG. 18 is an entire structural diagram of the conventional electronic mail information management system.

### DESCRIPTION OF REFERENCE NUMERALS AND SIGNS

101, 201, 301, 401: portable telephone
102, 202: communication network
103, 203, 303: communication counter terminal
104, 204: memory card
105, 205, 302, 402: secure card
106, 210, 413: environmental information registering unit
107, 222, 414: identification information database
108, 206: transmitting/receiving unit
109, 207, 304, 415: terminal application executing unit
110, 208, 305, 403: device processing unit
111, 212, 307, 405: information judging unit
112, 213, 308, 406: security verifying unit
113, 214, 309, 407: data analyzing unit
114, 215, 310, 408: permission information database
115, 216, 311, 409: permission information database updating unit
116, 217, 312, 410: data verifying unit
117, 218, 313, 411: isolation database
118, 219, 314, 412: verification database
119, 220: display unit
120: permission information data table
209: information processing unit
211, 306, 404: terminal processing unit
319, 417: memory unit
418: transmission source terminal

### BEST MODE FOR CARRYING OUT THE INVENTION

Referring now to drawings, embodiment modes of the present invention will be described.

### Embodiment Mode 1

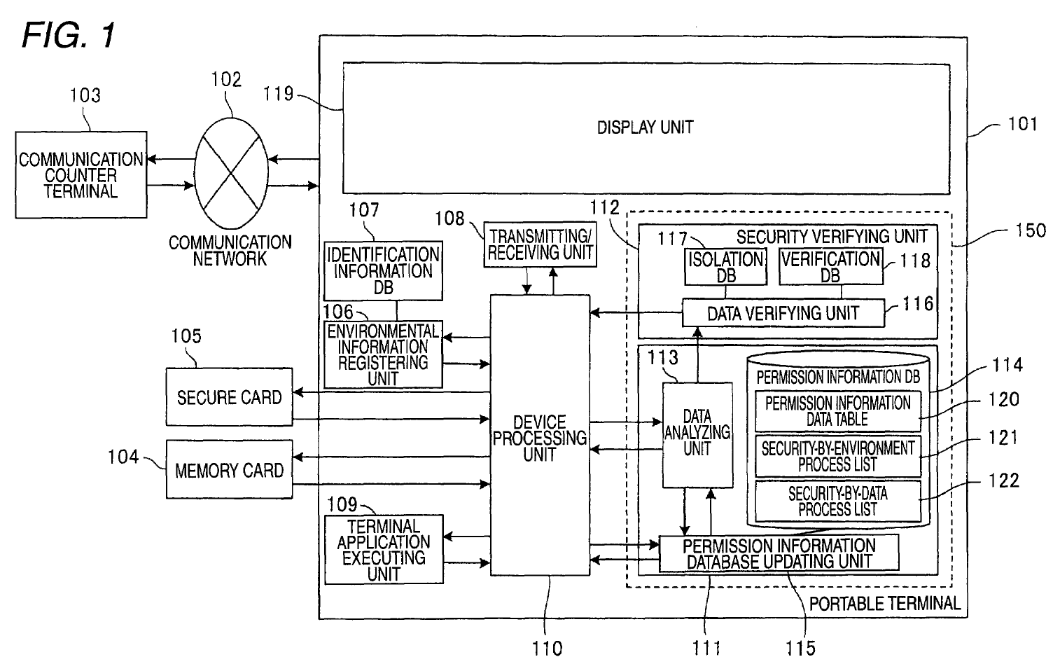

FIG. 1 is a block diagram for indicating an arrangement of an entire system as to an information transfer control apparatus according to an embodiment mode 1 of the present invention. As represented in FIG. 1, this system is equipped with a portable telephone 101, and means for communicating information via a communication network 102 to a communication counter terminal 103. On the portable telephone 101, a memory card 104 may be mounted, and this memory card 104 may be alternatively replaced by a secure card 105 which corresponds to a memory card provided with a smart card function. While the secure card 105 is equipped with a smart card module, this secure card 105 is provided with a secure memory region which has been encrypted by the smart card module, and a normal memory region.

Although the above-explained portable telephone 101 is illustrated in FIG. 1 as one example of the communication terminal, any other electronic appliances may be employed if these electronic appliances own information communication functions capable of transferring information by being connected to the communication network 102, for instance, PCs (Personal Computers), PDAs (Personal Digital Assistants), PHSs (Personal Handyphone Systems), digital televisions, other information communication appliances, and information communication household appliances.

Also, the connecting mode between the memory card 104 and the secure card 105 is not limited only to such a detachable mounting type that the secure card 105 is detachably mounted on the portable telephone 101 via a card slot, but may be realized by various connecting types, for example, a chip may be embedded in a communication terminal, and the secure card 105 may be connected via a USB interface, or a cable to a communication terminal.

Furthermore, outer shapes of the memory card 104 and the secure card 105 are not limited only to card types, but may be freely modified. That is, the secure card 105 may be realized as a device which mounts thereon a CPU having an anti-dumper region. Also, the memory card 104 may be realized as a recording medium connectable to the portable telephone 101.

The portable telephone 101 employed in the embodiment mode 1 of the present invention verifies data which is transmitted from the portable telephone 101 in response to an execution environment of the communication counter terminal 103 which is communicated via the communication network 102. In this case, the above-described execution environment implies a sort of a terminal such as a PC, a PDA, and a portable telephone, and also, implies an OS (Operating System) operated on this terminal. In the below-mentioned description, information for identifying this execution environment will be referred to as “environmental information” hereinafter.

Firstly, a description is made of an arrangement of the portable telephone 101. The portable telephone 101 is equipped with a identification information database 107, an environmental information registering unit 106, a transmitting/receiving unit 108, a terminal application executing unit 109, a device processing unit 110, an information judging unit 111, and a security verifying unit 112. The identification information database 107 has stored thereinto environmental information of the communication counter terminal 103 for communicating information with the portable telephone 101. The environmental information registering unit 106 acquires the environmental information of the communication counter terminal 103 from a received electronic mail etc. so as to register the acquired environmental information into the identification information database 107. The transmitting/receiving unit 108 is provided with a function capable of accessing the communication network 102. The terminal application executing unit 109 is operated on a terminal. The device processing unit 110 acquires transmission data from the terminal application executing unit 109. The information judging unit 111 determines a security process operation in response to an execution environment of the communication counter terminal 103 and a sort of data. The security verifying unit 112 executes the determined security process operation.

The above-explained information judging unit 111 is equipped with a permission information database 114, a data analyzing unit 113, and a permission information database updating unit 115. In the permission information database 114, security process operations have been defined in response to execution environments and sorts of data. The data analyzing unit 113 accesses the permission information database 114 so as to determine a security process operation which is executed with respect to data. The permission information database updating unit 115 updates the content of the permission information database 114. Also, the security verifying unit 112 is equipped with a data verifying unit 116, an isolation database 117, and a verification database 118. The data verifying unit 116 actually executes a security process operation. The isolation database 117 stores thereinto data to be isolated in the security process operation. The verification database 118 stores thereinto pattern data and the like, which are employed in the security process operation.

In an actual case, software modules provided with the functions as to the environmental information registering unit 106, the transmitting/receiving unit 108, the device processing unit 110, the data analyzing unit 113, the permission information database updating unit 115, and the data verifying unit 116 have been stored respectively in either a ROM or an EEPROM of the portable telephone 101, and then, since the CPU of the portable telephone 101 executes these software modules, the functions of these units are realized. Also, the terminal application executing unit 109 is realized by the OS of the portable telephone 101 and a group of application programs operated on this OS. Furthermore, the identification information database 107, the permission information database 114, the verification database 118, and the isolation database 117 are stored in a memory employed in the portable telephone 101.

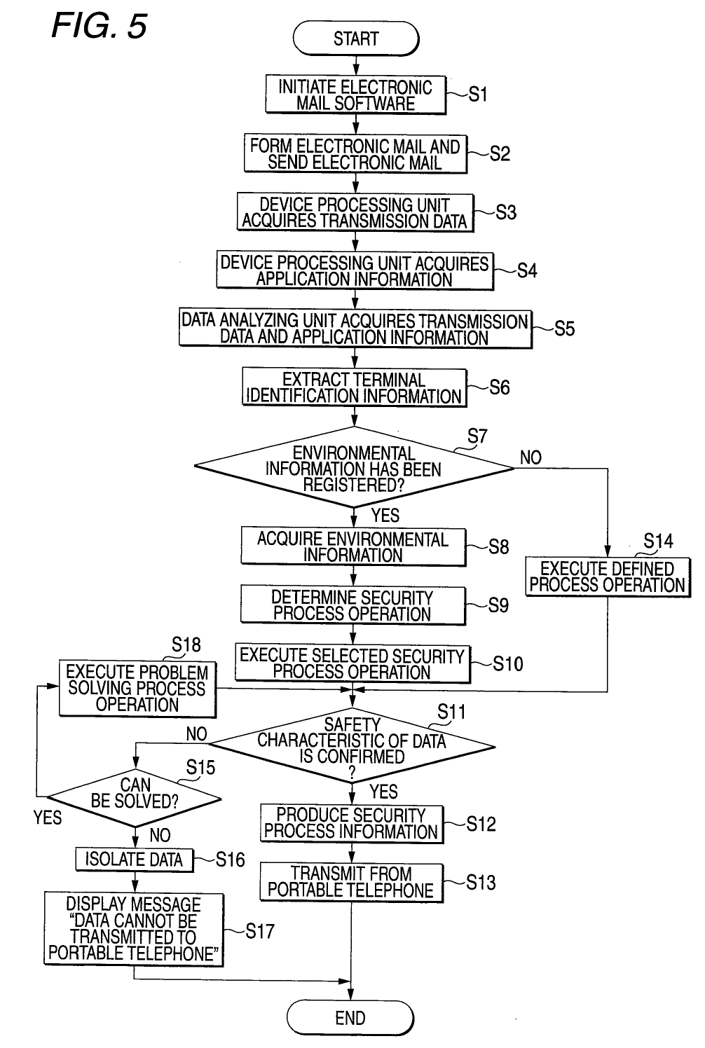

Operations of the portable telephone 101 employed in the embodiment mode 1 will now be described with reference to a flow chart of FIG. 5.

In this embodiment mode 1, a description is made of such a case that a user sends an electronic mail to the communication counter terminal 103 by employing the portable telephone 101. Assuming now that the communication counter terminal 103 is a PDA, the user does not recognize that the communication counter terminal 103 is the PDA. The user initiates electronic mail software by the terminal application executing unit 109 (step S1) so as to form an electronic mail, and then sends the electronic mail to the communication counter terminal 103 (step S2). The data transmitted from the terminal application executing unit 109 is received by the device processing unit 110 before being transferred to the transmitting/receiving unit 108 (step S3). The device processing unit 110 acquires application information such as a title and a version of an application program for transmitting the data from the terminal application executing unit 109 (step S4), and then, transmits the acquired data and the acquired application information to the data analyzing unit 113 (step S5).

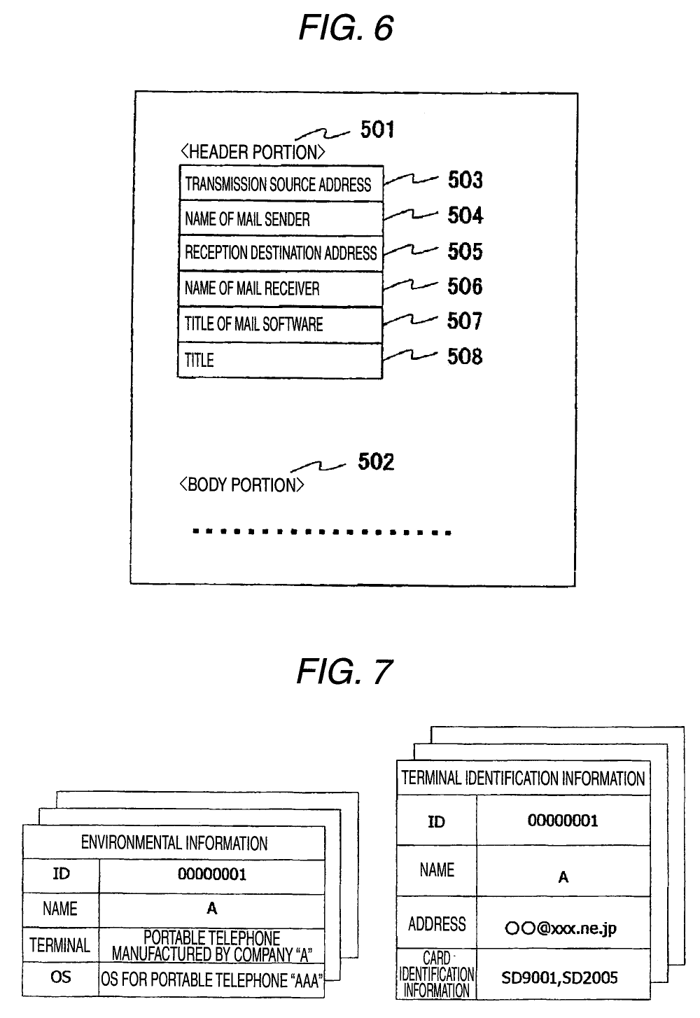

Generally speaking, as shown in FIG. 6, transmission data of an electronic mail is mainly constituted by a header portion 501 and a body portion 502. The header portion 501 contains a transmission source address 503, a name 504 of a mail sender, a reception destination address 505, a name 506 of a mail receiver, a mail software name 507, a title 508, and the like. The data analyzing unit 113 analyzes the header portion 501 of the acquired data so as to extract the reception designation address 505 and the name 506 of the mail receiver as terminal identification information which is used to identify a communication counter terminal (step S6). It should be understood that the extracted information will be referred to as “terminal identification information” in the below-mentioned description.

While a permission information data table 120 indicative of environmental information corresponding to terminal identification information is present in the permission information database 114, the data analyzing unit 113 accesses the permission information database 114 in order to refer to this accessed permission information data table 120, and checks as to whether or not such an environmental information of the communication counter terminal 103 has been registered therein which corresponds to the extracted terminal identification information (step S7). In the case that the environmental information corresponding to the terminal identification information has been registered, the data analyzing unit 113 acquires this registered environmental information (step S8). Furthermore, the permission information database 114 has held therein a security-by-environment process list 121 and a security-by-data process list 122. The security-by-sort process list 121 is such a list of security process operations corresponding to the above-described environmental information. The security-by-data process list 122 is a list of security process operations corresponding to sorts of data indicated by application information. The data analyzing unit 113 collates the acquired environmental information of the communication counter terminal 103 with the security-by-environment process list 121 in order to select a security process operation which is necessarily required for the environment of the communication counter party. Moreover, the data analyzing unit 113 collates the acquired application information with the security-by-data process list 122 so as to select a security process operation which is required in response to a sort of data. Then, the data analyzing unit 113 collates these selected results with each other so as to determine a security process operation which is finally executed (step S9).

The permission information data table 120 is such a table which indicates a correspondence relationship between terminal identification information and environmental information of terminals indicated by the terminal identification information. Under the above-explained restriction, the permission information data table 120 may be formed based upon various sorts of data structures. For instance, FIG. 7 shows one example of the permission information data table 120. In FIG. 7, the permission information data table 120 contains two tables, namely, a table for managing the terminal identification information and another table for managing the environmental information. The contents of these tables are related to each other based upon IDs indicative of owners of terminals. In the table for managing the terminal identification information, plural pieces of the terminal identification information have been managed for every ID; and with respect to one ID, such a terminal identification information as card identification information has been registered. The card identification information corresponds to a name of an owner of a terminal, a mail address of this owner, and a secure card and a memory card, which are owned by this owner. Also, in the table for managing the environmental information, plural pieces of the environmental information have been managed for the individual appliances, for example, terminals, secure cards, and memory cards. In this table, such information as a name of an owner of an appliance, an appliance sort, and an OS thereof has been registered with respect to one appliance.

For example, in the example shown in FIG. 7, in such a case that the reception destination address is “oo@xxx.ne.jp”, and the name of the mail receiver is “A” as the terminal identification information, the data analyzing unit 113 firstly refers to the table for managing the terminal identification information so as to specify that ID is “00000001”. Thereafter, the data analyzing unit 113 refers to the table for managing the environmental information so as to specify environmental information of a communication counter terminal having possibility of receiving data based upon the ID of “00000001.” In this case, the data analyzing unit 113 specifies that the appliance sort is such a portable telephone “A1002” manufactured by a company “a”, and the OS corresponds to such an OS designed for “AAA portable telephone.” At this time, in the case that a mail receiver owns a plurality of terminals and a plurality of environmental information have been registered based upon the same ID, the data analyzing unit 113 specifies the plural pieces of environmental information.

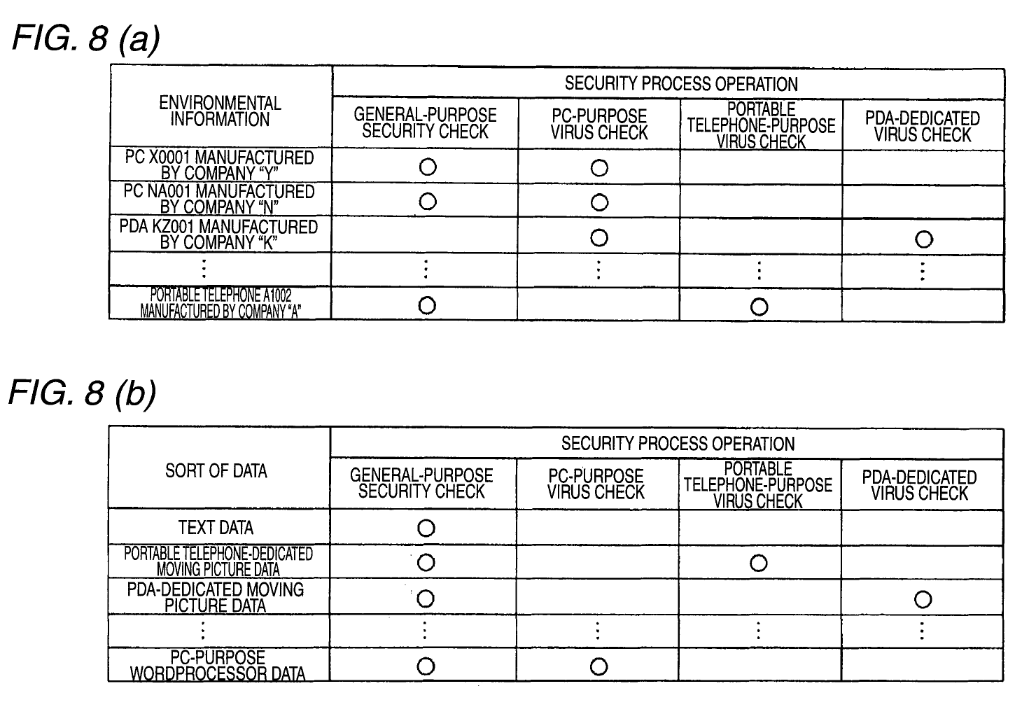

Next, the data analyzing unit 113 refers to the security-by-environment process list 121 so as to select a security process operation which corresponds to the environmental information specified by the process operation of the step S8. For instance, FIG. 8(a) schematically shows one example of a security-by-environment process list. In the security-by-environment process list 121, security process operations are represented which should be executed in correspondence with the respective environmental information. This example of the security-by-environment security process list shown in FIG. 8(a) represents executions of the below-mentioned security process operations: That is, in the case of a PDA K2001 manufactured by a firm “K”, both a PDA-purpose virus check and a general-purpose security check are carried out; and in the case of a portable telephone A1002 manufactured by a firm “a”, both the general-purpose security check and a portable telephone-purpose virus check are carried out. Assuming now that a mail receiver owns a plurality of terminals, in such a case that two sorts of the environmental information (namely, portable telephone A1002 manufactured by firm “K”, and PDA K2001 manufactured by firm “a”) are specified in the acquisition of the environmental information of the step S8, the data analyzing unit 113 refers to the above-explained list, so that security check application programs of the PDA-purpose virus check, the general-purpose security check, and the portable telephone-purpose virus check are selected as the security process operations corresponding to the portable telephone A1002 manufactured by the firm “K” and the PDA K2001 manufactured by the firm “a.”

The general-purpose security check described in the example of FIG. 8(a) corresponds to such a security process operation which is commonly executed, while does not depend upon environmental information of terminals. This general-purpose security check is, for example, a checking operation for checking as to whether or not personal information having a high secrecy such as a credit card number is contained in transmission data, and an upper limit check for a size of transmission data. Also, the virus checking operations such as the PDA-purpose virus check and the portable telephone-purpose virus check correspond to such a process operation for verifying as to whether or not a virus program for performing illegal operation is present under execution environment of a communication counter terminal. That is, since the portable telephone 101 executes this security process operation with respect to transmission data, the portable telephone 101 verifies as to whether or not the transmission data contains such a virus which performs illegal operations on a platform of the communication counter terminal.

It should also be noted that while the security process operations described in this example are not limited only to the general-purpose security check program and the virus check program, various sorts of security process operations with respect to information to be transferred may be mounted and selected. For instance, while lists as to a security policy, transmission permission information, and the like are recorded in the permission information database 114, such a security process operation may be selected which judges as to whether or not a transmission of transmission data is permitted in accordance with a content of data, and a communication counter party.

Next, the data analyzing unit 113 refers to the security-by-data process list 122 so as to select a security process operation which corresponds to the sort of the transmission data. For instance, FIG. 8(b) schematically shows one example of a security-by-data process list. In the security-by-data process list 122, security process operations are represented which should be executed in correspondence with the sorts of data. This example of the security-by-data security process list shown in FIG. 8(b) represents executions of the below-mentioned security process operations: That is, in the case of text data, the general-purpose security check is carried out, whereas in the case of moving picture data dedicated to portable telephones, both the general-purpose security check and the portable telephone-purpose security check are carried out respectively.

Next, the data analyzing unit 113 collates the security process operation selected by referring to the security-by-environment process list 121 with the security process operation selected by referring to the security-by-data process list 122 so as to determine such a security process operation which is finally executed (step S9).

For example, in the case that the security-by-environment process list 121 and the security-by-data process list 122 are the examples shown in FIG. 8(a) and FIG. 8(b) respectively, when the application information of the transmission data is specified as a portable telephone-purpose video camera application program, the sort of the transmission data is specified as portable telephone-dedicated to moving data, and the environmental information of the communication counter terminal is specified as a portable telephone A1002 manufactured by the firm “K”, and the PDA K2001 manufactured by the firm “a”, the data analyzing unit 113 refers to the security-by-environment process list 121 so as to select three sorts of security process operations constituted by the PDA-purpose virus check, the general-purpose security check, and the portable telephone-purpose virus check. Also, the data analyzing unit 113 refers to the security-by-data process list 122 so as to select two sorts of the security process operations constituted by the general-purpose security check and the portable telephone-purpose security check. Furthermore, the data analyzing unit 113 collates these selected results with each other so as to finally determine two sorts of the security process operations, namely the general-purpose security check and the portable telephone-purpose virus check as the security process operation which should be carried out.

As previously explained, since the data analyzing unit 113 collates the security process operation selected by referring to the security-by-environment process list 121 with the security process operation selected by referring to the security-by-data process list 122, the data analyzing unit 113 can limit the security process operations which are executed to only the necessary process operation. As a result, the load of the security process operation can be eventually reduced.

In the above explanation, the data analyzing unit 113 has performed both the selection of the security process operation by referring to the security-by-environment process list 121 and the selection of the security process operation by referring to the security-by-data process list 122. Alternatively, the data analyzing unit 113 may perform only one of these selections. For instance, in such a case that a sort of data cannot be specified, e.g., when application information of transmission data cannot be acquired, while the data analyzing unit 113 does not select the security process operation by referring to the security-by-data process list 122, the data analyzing unit 113 determines such a security process operation which is executed based upon the selection result of the security process operation by referring to the security-by-data process list 121.

Thereafter, the data analyzing unit 113 notifies the security process operation determined in combination with the transmission data. While the programs of the security process operations have been held by the data verifying unit 116, the data verifying unit 116 executes the program of the notified security process operation (step S10). For example, in the case that two sorts of security checks, namely both the general-purpose security check and the portable telephone-purpose virus check are notified as the security process operation, the data verifying unit 116 executes the program of the general-purpose security check and the program of the portable telephone-purpose virus check one by one so as to sequentially execute the security process operations with respect to the transmission data (step S10). Pattern data such as a pattern matching system have been registered in the verification database 118 which is provided by the data verifying unit 116. Next, the data verifying unit 116 judges results of the security process operations (step S11), and when the safety characteristic of the transmission data is confirmed by passing all of the security process operations, the data verifying unit 116 produces such a security process information which certificates that the security process operations have been carried out with respect to the transmission data, and adds this processed security process information to the transmission data (step S12), and then, passes the transmission data to the device processing unit 110.

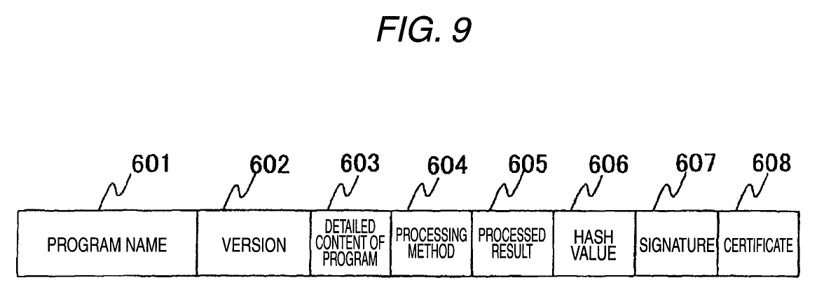

FIG. 9 represents a data structure of security process information. While the security process information is information related to such an executed security process operation, this security process information is constituted by a program name 601 of security processing application software, version information 602 of the application software, a detailed content 603 of a problem, a processing method 604, a processed result 605, a hash value 606 of transmission data, a signature 607, and a public key certificate 608. The detailed content 603 of the problem implies such detailed problem contents when a problem of a virus infection occurs, namely, a sort of a virus, an execution environment of the virus, and a damage when the virus is executed. The signature 607 is made with respect to the data defined from the program name 601 up to the hash value 606 of the transmission data. The public key certificate 608 certificates that the above-described signature 607 is issued from a mail sender. Both the detailed problem content 603 and the processing method 604 correspond to such data contained in the case that a certain problem in view of a security is contained in transmission data, for example, in such a case that a virus is discovered in a security process operation. When no problem is contained in transmission data, the detailed problem content 603 and the processing method 604 are not contained in the transmission data. In the detailed problem content 603, the below-mentioned problem contents have been described, namely information related to a detected virus, for example, a sort of the virus, an execution environment of the virus, and a damaged content when the virus is executed. In the processing method 604, such an information has been described, for example, extermination of a virus, and a way how to solve the virus problem.

It should also be noted that the calculations as to the hash value 606 of the transmission data and the signature 607 are performed not only by employing the public key calculation function provided by the CPU of the portable telephone 101, but also by employing the calculation function of the IC chip embedded in the portable telephone 101 which is independently provided with the portable telephone 101.

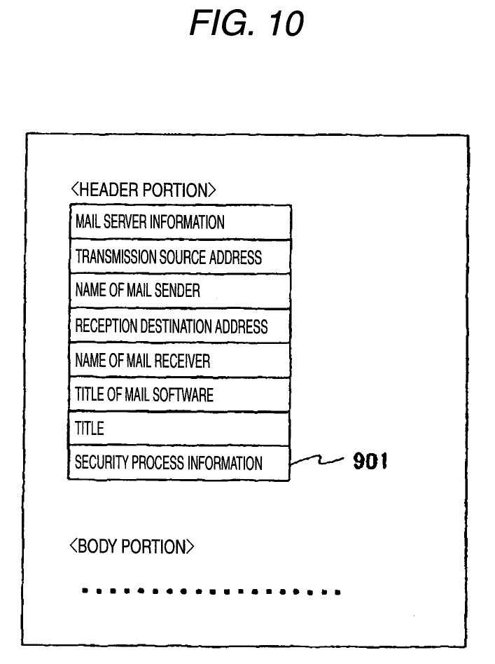

As indicated in FIG. 10, after the above-described security process information has been written in the header portion of the transmission data by the device processing unit 110, the resulting data is transmitted by the transmitting/receiving unit 108 as the transmission data which contains the security process information (step S13). As a result, the transmission data ensures such a fact that illegal data is not discovered within the range described in the security process information with respect to an owner of a communication counter terminal.

Also, in the step S7, in the case that the environmental information corresponding to the terminal identification information has not been registered in the permission information database 114, a predetermined existing security process operation is selected to be executed (step S14). To select the existing security process operation, for example, a security process operation corresponding to a communication terminal having the highest general-purpose characteristic is selected to be set on the user side.

In the case that the terminal identification information has not yet been registered in the permission information database 114, such terminal identification information as a reception destination address and a name of a mail receiver which are extracted from the transmission data is transferred from the data analyzing unit 113 to the permission information database updating unit 115, and then, is newly added into the permission information data table 120 in the permission information database 114.

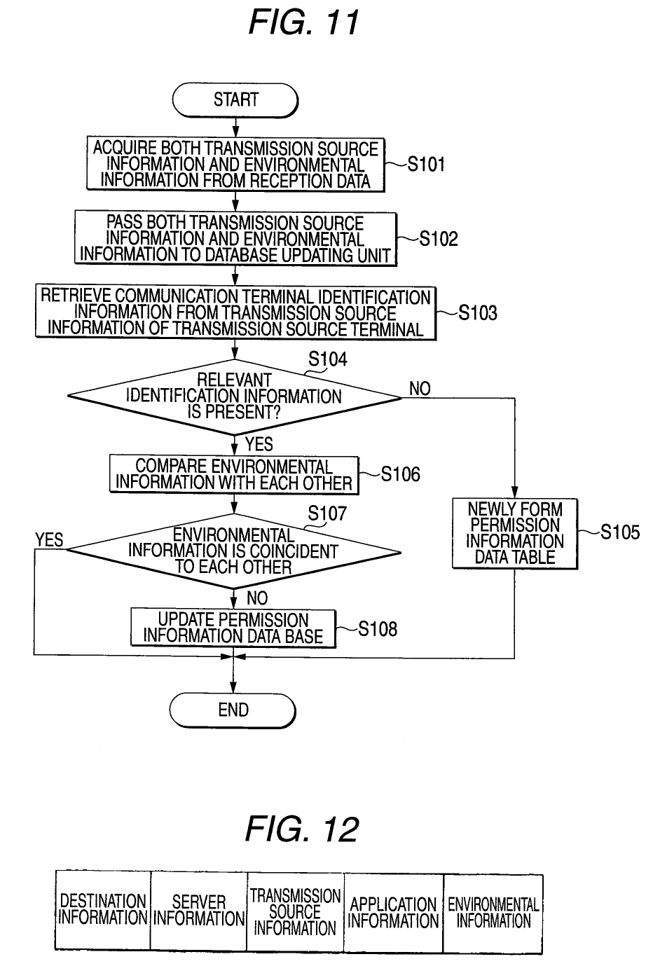

The terminal identification information is newly registered and updated in the permission information data table 120 of the above-explained permission information database 114 used to select the security process operation by inputting the terminal identification information by the user and by automatically extracting the terminal identification information from the reception data received by the portable telephone 101. A description is made of updating operations by automatically extracting terminal identification information from the reception data as to the permission information database 112 in accordance with a flow chart of FIG. 11.

When the device processing unit 110 receives data via the transmitting/receiving unit 108 from the communication network 102, the device processing unit 110 passes this received data to the environmental information registering unit 106. FIG. 12 shows a structural diagram of a header portion of the reception data. The header portion contains various information such as server information, transmission source information, application information, environmental information, and the like. The environmental information registering unit 106 extracts both the transmission source information and the environmental information from the header portion of the reception data received from the communication network 102, and then, records the extracted information in the identification information database 107 held by the environmental information registering unit 106 (step S101). Then, the environmental information registering unit 106 passes the extracted information via the device processing unit 110 to the permission information database updating unit 115 (step S102). The permission information database updating unit 115 accesses the permission information database 114 in order to retrieve as to whether or not the transmission source information such as a name and an address has been registered as the identification information in the permission information data table 120 (step S103). If the transmission source information is not present in the permission information data table 120 (NO: in step S104), then the permission information database updating unit 115 registers the acquired transmission source information as terminal identification information into a table for managing the terminal identification information, registers the acquired environmental information as the environmental information of the communication counter party into a table for managing the environmental information, registers the same IDs with respect to the reception information, and also newly registers than into the permission information data table 120 (step S105). In the case that any one of the name and the address among the acquired transmission source information has already been registered as the terminal identification information in the permission information database 114 (YES: step S104), the permission information database updating unit 115 compares both the acquired transmission source information and the acquired environmental information with both the terminal identification information and the environmental information which have already been registered in the permission information database 114 (step S106) in order to verify as to whether or not all of these information items are identical to each other (step S107). When even one information not registered in the permission information database 114 is present, the permission information database updating unit 115 registers either the transmission source information or the environmental information, which has not yet been registered, into the permission information database 114 so as to update the permission information database 114 (step S108).

Also, in the case that both the terminal identification information and the environmental information of the communication counter terminal 103 having no reception history are newly registered, the user manipulates keys of the portable telephone 101 to set the above-described information in accordance with operations displayed on the display unit 119. At this time, when the environmental information of the communication counter terminal 103 can be hardly specified, only the terminal identification information is registered. In this case, if the data analyzing unit 113 refers to the newly registered permission information data table 120 when the data is transmitted, then there is no environmental information corresponding to the terminal identification information. As a result, the data analyzing unit 113 selects the preset existing security process information and notifies the selected existing security process information to the data verifying unit 116 (step S14).

In the judging operation of the security processed result in the step S11 of FIG. 5, when a certain problem in the security aspect is present in the transmission data (for example, virus is discovered), the data verifying unit 116 judges as to whether or not this problem can be solved (step S15). When the problem can be solved, for instance, the virus can be exterminated, the data verifying unit 116 executes a process operation capable of solving this problem (step S18), and then the process operation is again returned to the judgement of the security processed result of the step S11. In such a case that the problem cannot be solved and exterminated and the safety characteristic of the transmission data cannot be achieved, the data verifying unit 116 isolates the transmission data to the isolation database 117, and transfers only the security process information to the device processing unit 110 (step S16). The device processing unit 110 displays such a message that the transmission data cannot be transmitted to the communication counter terminal 103 on the display unit 117 of the portable telephone 101 in combination with the security process information (step S17). In this case, when the owner of the communication counter terminal recognizes from the security process information such a fact that the security process problem occurs in which execution environment and thereafter the owner wants to transmit the transmission data, the device processing unit 110 derives the isolated data from the isolation database 117 and then transmits the derived data. In the isolation database 117, the below-mentioned data have been stored, namely, while a problem occurs in a security process operation, data cannot be deleted, and a transmission of data is not permitted since other security process operations cannot be carried out.

In the above explanations, the terminal identification information has been explained as the name and the mail address. However, the terminal identification information is not limited only to the above-explained items, but may be alternatively realized as identifiers capable of specifying an IP address, a product name of a communication counter terminal, a product sort, a product model number, and the like.

Also, the environmental information is not limited only to the flatform information such as the OS, but may be alternatively realized as such information capable of specifying a program execution environment of a communication counter terminal and a view environment of data.

Furthermore, the security process information is not limited only to such an information that the security process operation is added to the header of the electronic mail, but may be alternatively realized by the following means: That is, means notifies information such as a security process operation executed in a communication counter terminal and a result of this security process operation, for instance, the security process information may be encoded on text data and the encoded security process information may be attached to transmission data, or may be transmitted irrespective of the transmission data.

Also, in the step S104 and the step S106, the permission information database updating unit 115 may alternatively analyze the terminal identification information so as to specify environmental information, or may alternatively specify the environmental information from the Internet by utilizing the communication network 102. For example, in such a case that while an address of an electronic mail is specified as transmission source information, this electronic mail address corresponds to such an address that a communication carrier of a portable telephone is used as a domain, the permission information database updating unit 115 may specify environmental information in such a manner that a communication terminal corresponds to the portable telephone having this communication carrier. Also, if a product name and a model number of a communication terminal have been recorded in transmission source information, then the permission information database updating unit 115 may alternatively acquire information related to this communication terminal based upon the recorded information from a home page of a manufacturing company which provides this communication terminal, and a site of product information thereof, and then, may record the acquired information as the environmental information in the table for managing the environmental information.

To this end, when the relevant information is newly registered in the permission information data table 120, or the permission information data table 120 is updated, the permission information database updating unit 115 verifies the extracted transmission source information and the content of the permission information data table 120 related thereto. In the case that the electronic mail address having the specific domain name, the product name, and the model number have been registered, the permission information database updating unit 115 requests the device processing unit 110 to be connected to the communication network 102 and acquires the environmental information. When the device processing unit 110 acquires the environmental information from the Internet, the acquired environmental information is transferred to the permission information database updating unit 115. Then, the permission information database updating unit 115 registers the acquired environmental information and the terminal identification information into the permission information data table 120 in correspondence thereto. Then, the permission information database updating unit 115 notifies such a fact that the updating operation of the permission information database 114 is accomplished to the data analyzing unit 113. The data analyzing unit 113 accesses the updated permission information database 114, and acquires the environmental information of the communication counter terminal so as to determine a security process operation which should be carried out.

It should also be noted that before the device processing unit 110 is connected to the communication network 102, the permission information database updating unit 115 may request the user to permit the connection to the communication network 102, or may alternatively set such a condition that the connection to the communication network 102 so as to acquire the environmental information is not carried out.

Also, the portable telephone 101 may control not only the communication destination terminal 103 via the communication network 102, but also control information which is transferred from the portable telephone 101 to either the memory card 104 or the secure card 105. The structure of the portable telephone 101 is basically identical to that of such a case that the data is transmitted via the communication network 102 as explained above, but owns the following different points. That is, the card identification information of the secure card (otherwise memory card) is employed as the terminal identification information, and also, the data to which the security process operation has been performed and whose safety characteristic can be confirmed is written into the memory card (or secure card). In this case, since the card identification information of the secure card (or memory card) is employed as the terminal identification information, the communication terminal owned by the owner of the secure card (or memory card) is specified.

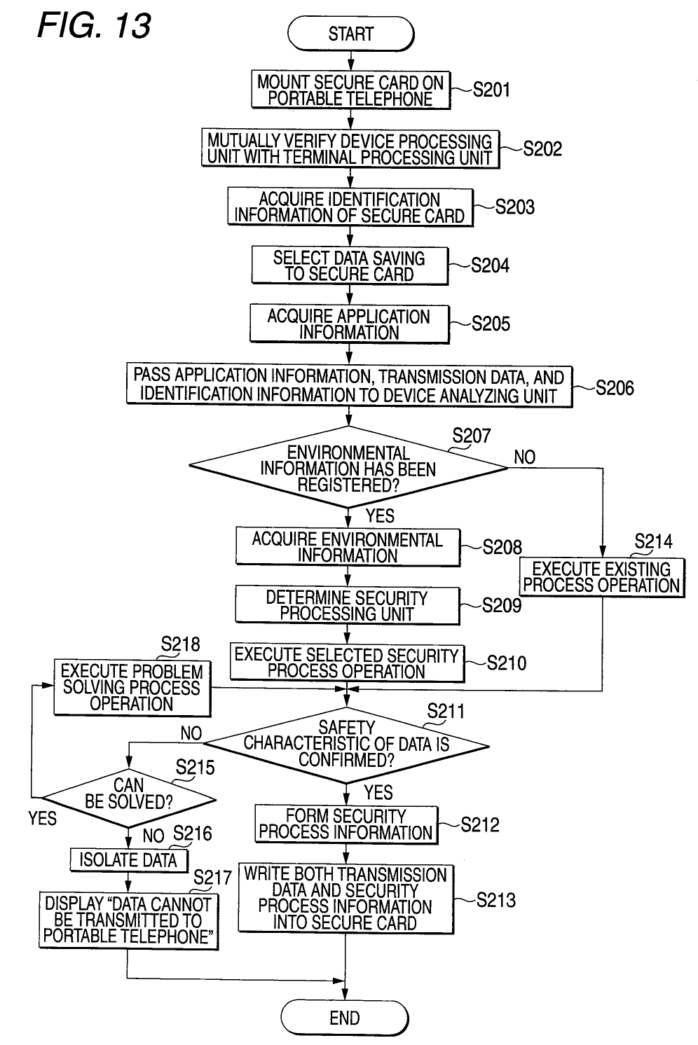

Referring now to a flow chart of FIG. 13, a description is made of process operations executed in the case that data is transferred to the secure card 104 which is owned by an owner “A” of a communication counter terminal.

When the user mounts the secure card 105 on the portable telephone 101 (step S201), the portable telephone 101 recognizes mounting of the secure card 105, and a mutual verification process operation is performed between the device processing unit 110 and the secure card 105 (step S202). At this time, the device processing unit 110 acquires card identification information from the secure card 105 at the same time (step S203) while the card identification information identifies a secure card, or specifies an owner of the secure card. The acquired card identification information is saved in the device processing unit 110 until disconnecting of the secure card 105 is sensed.

Next, the user initiates an application program by the terminal application executing unit 109, and selects saving of data by an operation menu (step S204). When the secure card 105 is selected as the save destination, the device processing unit 110 acquires data from the terminal application executing unit 109. Also, the device processing unit 110 acquires application information such as an application name and a version thereof for transmitting the data, an extension from the terminal application executing unit 109 (step S205). The device processing unit 110 passes the card identification information of the secure card 105 to the data analyzing unit 113 (step S206), while the card identification information has been held as the transmission data, the application information, and further, the terminal identification information.

Thereafter, in a process operation of a step S213, process operations defined from a step S207 up to a step S218 are basically identical to the process operations defined from the step S7 up to the step S18 as explained in the flow chart of FIG. 5 except that the transmission data is not transmitted via the communication network 102, but is written in the secure card 104. As a consequence, only such a data whose safety characteristic has been confirmed is written in the secure card 105, whereas data whose safety characteristic has not been finally confirmed is not written in the secure card 105.

In this case, while both the environmental information of the communication terminals owned by the card holders of the secure cards and the environmental information of the secure cards have been registered in the permission information data table 120, in the process operation for specifying the environmental information of the step S208, the data analyzing unit 113 specifies environmental information of the communication terminal owned by the card holder of the secure card 105 and environmental information of the secure card 105. Also, in the process operation for selecting the security process operation based upon the environmental information of the step S209, the data analyzing unit 113 selects a security process operation based upon both the environmental information of the communication terminal owned by the card holder of the secure card 105 and the environmental information of the secure card 105. As a consequence, in the process operation of the step S210, there are some possibilities that the security process operation selected based upon the environmental information of the secure card is carried out.

In the above explanation, the security process operation is selected based upon both the environmental information of the communication terminal owned by the card holder of the secure card and the environmental information of the secure card. Alternatively, the security process operation may be selected based upon the environmental information of the communication terminal owned by the card holder of the secure card.

Although the secure card 105 is owned by the communication counter party to which the data is passed, in such a case that the data is passed to the communication counter terminal while the secure card 105 which is owned by a person who passes the data is employed as the bridge medium, the card identification information does not constitute the terminal identification information. As previously explained, in the case that the owner of the secure card 105 is different from the owner of the communication counter terminal, if the secure card 105 is selected as the saving destination, then the terminal identification information is selected in the case that the terminal identification information is selected via the display unit 119 from the information of the permission information database 114.

Concretely speaking, when saving of the data to the secure card 105 is selected, the device processing unit 110 requests the data analyzing unit 113 to acquire the terminal identification information of the permission information database 114, and then, the data analyzing unit 113 passes a name list from the terminal identification information registered in the permission information database 114 to the device processing unit 110. If this name list is displayed on the display unit 119 and the user selects a name of a counter party who utilizes the secure card 105, then the selected name is transferred as the terminal identification information in combination with the transmission data and the application information to the data analyzing unit 113.

Also, as the data saving destination, the secure card 105 has been exemplified. Alternatively, the normal memory card 104 may be employed. In this alternative case, similar to the above-described case of the secure card 105, the card identification information of the memory card 104 may be employed as the terminal identification information. It should also be understood that when the above-described memory card 104 is such a type of memory card whose card identification information is not recorded, the card identification information cannot be utilized as the judging material of the terminal identification information for selecting the security process operation. As a consequence, when the memory card 104 is mounted, if the device processing unit 110 recognizes that the card identification information is not recorded on the memory card 104, then the selection screen of the terminal identification information is displayed via the display unit 119 and the device processing unit 110 determines the relevant terminal identification information in a similar manner to that of the secure card 105. Also, identification information indicative of a preset memory card is transferred to the data analyzing unit 113 as the terminal identification information. In this case, while the environmental information corresponding to the identification information indicative of the memory card 104 and the security process information have been previously determined in the permission information database 114, the data analyzing unit 113 refers to these security information items so as to select the security process operation, and notifies this selected security process operations to the data verifying unit 116. Thereafter, the data verifying unit 116 executes the security process operation and records data in combination with the security process operation on the memory card 104.

It should also be noted that as indicated by a broken line 150 in FIG. 1, the respective function blocks of the information judging unit 111 and the security verifying unit 112 may be alternatively realized in the form of an integrated circuit, concretely speaking, an LSI. Alternatively, these function blocks may be separately integrated in one chip form, or either a portion of these function blocks or all of these function blocks are contained in a single chip. Although the above-explained integrated circuit is formed as the LSL, this integrated circuit may also be referred to as an IC, a system LSI, a super LSI, and an ultra LSI, depending upon integration degrees thereof. Also, the method for manufacturing the integrated circuit is not limited only to an LSI, but may be realized as either a dedicated circuit or a general-purpose processor. Further, an FPGA (Field Programmable Gate Array) capable of being programmed after an LSI has been manufactured may be utilized, or a configurable processor in which connections and setting of circuit cells within an LSI can be reconstructed may be utilized.

In addition, if such an integrated circuit configuration technique which can replace an LSI will be developed in accordance with other technical ideas derived from semiconductor techniques or progresses of the semiconductor techniques, then it is so apparent that the function blocks may be alternatively integrated by employing this new integrated circuit configuration technique. There are certain possibilities that biotechnology is applied. Since the integrated circuit in the LSI form is employed, the portable telephone 101 may be made compact.

In accordance with the above-explained arrangement, in such a case that a security apparatus installed on a server, or a gateway is not valid in P2P communications among communication terminals, a security check function having a higher efficiency is realized on a communication terminal in correspondence with an environment of a communication destination. As a result, while securities with respect to information transferring operations can be emphasized, communication terminals, secure devices, and integrated circuit capable of preventing transmissions of illegal information can be realized.

In other words, the security process operation can be carried out based upon the environment of the communication counter terminal. As a consequence, the safety characteristic of the data to be transmitted to the communication counter terminal can be grasped and secured by the transmission-sided terminal without via the security process operation on the server. Also, it is possible to prevent a secondary infection in the case that the transmission-sided terminal is infected by a computer virus. Moreover, the security process operations can be carried out based upon the environments of the communication counter terminal not only when data is transferred via a communication network, but also when data is transferred via a bridge medium.

### Embodiment Mode 2

An embodiment mode 2 of the present invention is arranged as follows: That is, while the function of the security process operation indicated by the broken line 150 and provided in the portable telephone in the embodiment mode 1 is provided in a secure card as a data bridge medium, a necessary security process operation is carried out in the secure card with respect to data transmitted from the portable telephone, and thereafter, the security-processed data is transmitted from the portable telephone.

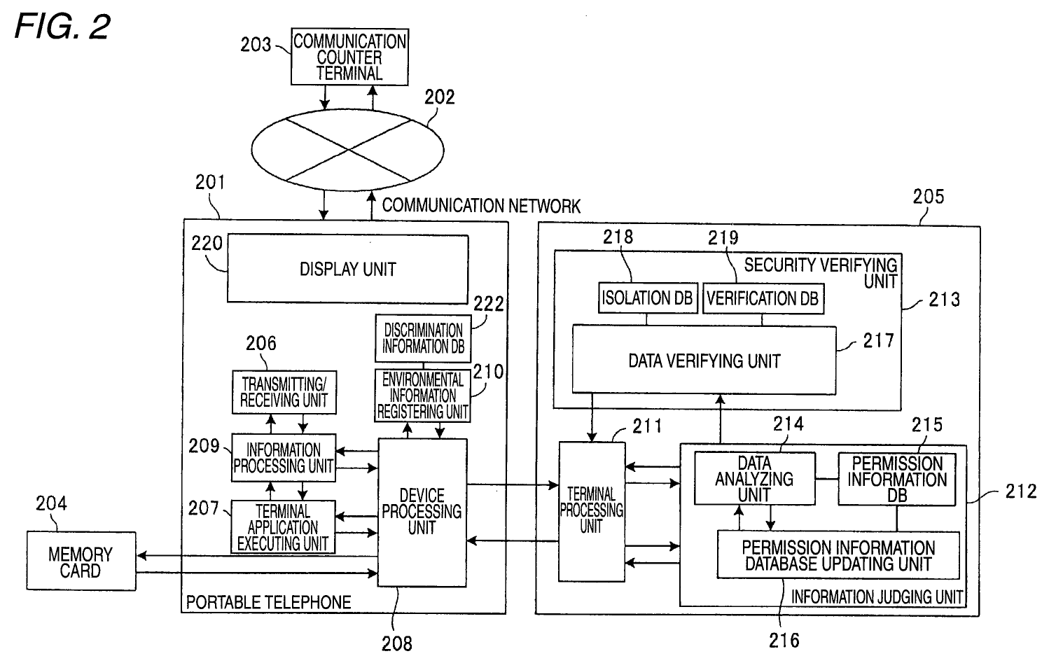

FIG. 2 is a block diagram for indicating an arrangement of an entire system as to an information transfer control apparatus according to an embodiment mode 2 of the present invention. As represented in FIG. 2, this system is equipped with a portable telephone 201, and means for communicating information via a communication network 202 to a communication counter terminal 203. On the portable telephone 201, a memory card 204 and a secure card 205 may be mounted. While the secure card 205 is equipped with a smart card module, this secure card 205 is provided with a secure memory region which has been encrypted by the smart card module, and a normal memory region.

Although the above-explained portable telephone 201 is illustrated in FIG. 2 as one example of the communication terminal employed in this embodiment mode, any other electronic appliances may be employed if these electronic appliances own information communication functions capable of transferring information by being connected to a communication network, for example, a desk top PC, a notebook PC, a PDA, a PHS, a digital television, other information communication appliances, and information communication household appliances.

Also, the connecting mode between the memory card 204 and the secure card 205 is not limited only to such a detachable mounting type that the secure card 205 is detachably mounted on the portable telephone 201 via a card slot, but may be realized by various connecting types, for example, a chip may be embedded in a communication terminal, and the secure card 205 may be connected via a USB interface, or a cable to a communication terminal.

Furthermore, outer shapes of the memory card 204 and the secure card 205 are not limited only to card types, but may be freely modified. That is, the secure card 205 may be realized as a device which mounts thereon a CPU having an anti-dumper region. Also, the memory card 204 may be realized as a recording medium connectable to the portable telephone 201.

The portable telephone 201 employed in the embodiment mode 2 of the present invention verifies data which is transmitted from the portable telephone 101 in response to an execution environment of the communication counter terminal 103 which is communicated via the communication network 102.

Firstly, a description is made of an arrangement of the portable telephone 201. The portable telephone 201 is equipped with a transmitting/receiving unit 206, a terminal application executing unit 207, a device processing unit 208, an information processing unit 209, an environmental information registering unit 210, an identification information database 222, and a display unit 220. The transmitting/receiving unit 206 is provided with a function capable of accessing the communication network 202. The terminal application executing unit 207 is operated on a terminal. The device processing unit 208 acquires transmission data from the terminal application executing unit 207. The information judging unit 209 changes a transmission path of data. The environmental information registering unit 210 acquires environmental information. The identification information database 222 stores thereinto the environmental information.

The above-explained secure card 205 is equipped with a terminal processing unit 211, an information judging unit 212, and a security verifying unit 213. The terminal processing unit 211 receives transmission data from the device processing unit 208. The information judging unit 212 determines a security process operation in response to an environment of an OS of the communication counter terminal 203. The security verifying unit 213 executes the determined security process operation. Also, the information judging unit 212 is equipped with a data analyzing unit 214, a permission information database 215, and a permission information database updating unit 216. The security verifying unit 213 is equipped with a data verifying unit 217, an isolation database 218, and a verification database 219.

In an actual case, software modules provided with the functions as to the transmitting/receiving unit 206, the device processing unit 208, the information processing unit 209, and the environmental information registering unit 210 have been stored respectively in either a ROM or an EEPROM of the portable telephone 201, and then, since the CPU of the portable telephone 201 executes these software modules, the functions of these units are realized. Also, the terminal application executing unit 207 is realized by the OS of the portable telephone 201 and a group of application programs operated on this OS. Also, the identification information database 222 is stored in a memory employed in the portable telephone 201.

In addition, software modules equipped with various functions as to the terminal processing unit 211, the data analyzing unit 214, the permission information database updating unit 215, and the data verifying unit 210 have been stored respectively in either a ROM or an EEPROM of an LSI chip provided in the secure card 205. These software modules are executed by a CPU of the secure card 205, so that the various functions are realized. Also, the permission information database 215, the isolation database 216, and the verification database 219 are stored in either a memory of the secure card 205 or a secure memory region which is encrypted by a smart card module, so that these functions are realized. Also, while the transmission data is temporarily stored in the secure memory region within the secure card 205, the respective software modules as to the terminal processing unit 211, the data analyzing unit 214, the permission information database updating unit 215, and the data verifying unit 210 access the secure memory region so as to access the transmission data.

These structural elements other than the terminal processing unit 211 and the information processing unit 209 correspond to the structural elements contained in the portable telephone 101 of the embodiment mode 1. That is, the data analyzing unit 214 corresponds to the data analyzing unit 113; the permission information database 215 corresponds to the permission information database 114; the permission information database updating unit 216 corresponds to the permission information database updating unit 115; the data verifying unit 217 corresponds to the data verifying unit 116; the isolation database 218 corresponds to the isolation database 117; verification database 219 corresponds to the verification database 118; the environmental information registering unit 210 corresponds to the environmental information registering unit 106; and the identification information database 222 corresponds to the identification database 107, and then, the respective units are operated in similar manners thereto.

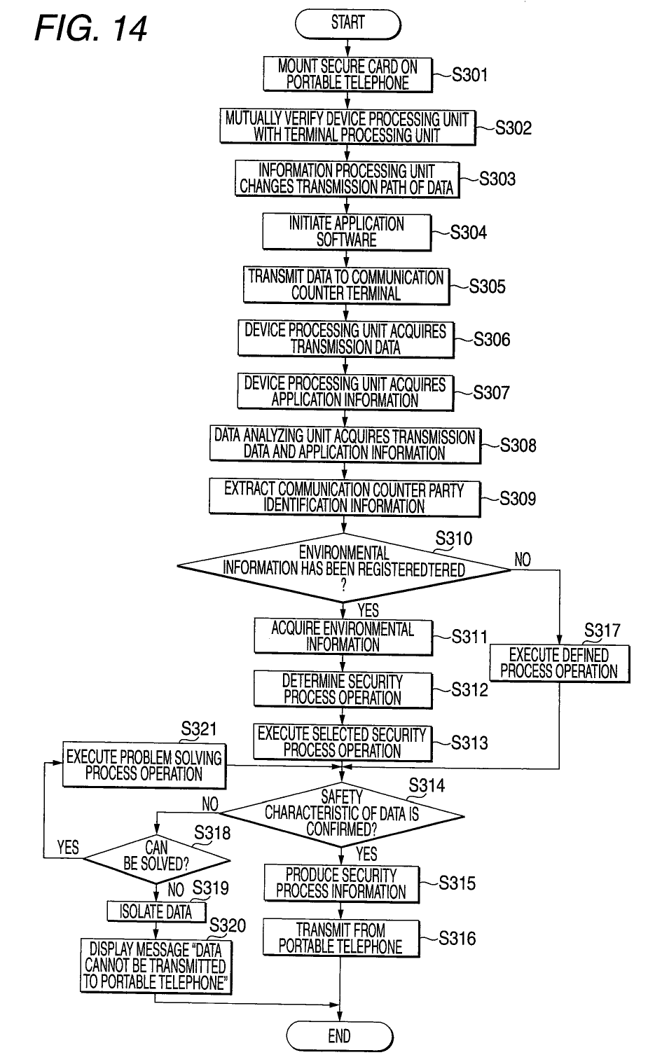

Referring now to a flow chart of FIG. 14, operations as to a communication terminal and a secure device will be described which are employed in this embodiment mode 2.

In the embodiment mode 2, in the case that a user transmits data to the communication counter terminal 203 by employing the portable telephone 201, the user firstly mounts the secure card 205 on the portable telephone 201 (step S301). If the portable telephone 201 recognizes mounting of the secure card 205, then a mutual verification process operation is carried out between the device processing unit 208 and the terminal processing unit 211 in order to verify that the secure card 205 is such a card which has been previously registered in the device processing unit 208 (step S302). In order to change a transmission path of data in such a manner that before the data transmitted from the terminal application executing unit 207 is passed to the transmitting/receiving unit 206, the transmission data is transmitted to the device processing unit 208, the device processing unit 208 loads the software module of the information processing unit 209, and the information processing unit 209 is provided between the terminal application executing unit 207 and the transmitting/receiving unit 206 (step S303).

The user initiates an application program by the terminal application executing unit 207 (step S304) so as to transmit data in the communication counter terminal 203 (step S305). Before the data transmitted from the terminal application executing unit 207 is passed to the transmitting/receiving unit 206, this data is transmitted to the device processing unit 208 by the information processing unit 209 (step S306). The device processing unit 208 acquires from the terminal application executing unit 207, such application information as a name and a version of an application program for transmitting the data (step S307), and then, transmits both the acquired data and application information to the data analyzing unit 211 via the terminal processing unit 211 (step S308).

Thereafter, process operations defined from a step S309 to a step S321 are basically performed in the same processing manners of the process operations defined from the step S6 to the step S18 in the explanations of the flow chart of FIG. 5 respectively. As a result, only data whose safety characteristic has been confirmed is transmitted to the communication counter terminal S203, whereas data whose safety characteristic has not been finally confirmed is not transmitted to the communication counter terminal S203.

Also, the portable telephone 201 can perform information transfer control operations not only to the communication counter terminal 203 via the communication network 202, but also from the portable telephone 201 to the memory card 204. The arrangement of the portable telephone 201 is basically identical to that of the above-explained case that the data is transmitted via the communication network 202, but owns the following different point. That is, the portable telephone 201 writes the data whose safety characteristic has been confirmed by executing the security processing operation into the memory card 204. In this case, since the name of the card holder as to the memory card 204 is employed as the terminal identification information, such a communication terminal is specified, which is conceivable that the card holder of the memory card 204 owns this communication terminal and mounts thereon the memory card 204. The transfer control process operations of the information to the memory card 204 in the embodiment mode 2 are basically performed in the same processing manners of the process operations defined from the step S204 to the step S218 in the explanations of the flow chart of FIG. 13 except that the data saving destination is not the secure card 105, but the memory card 204. As a result, only data whose safety characteristic has been confirmed is transmitted to the memory card 204, whereas data whose safety characteristic has not been finally confirmed is not transmitted to the communication counter terminal S203.

Also, similar to the case of the embodiment mode 1, the permission information database updating unit 216 newly registers and updates the above-explained permission information database 215 used to select the security process operation by way of a registering operation by an input of a user, and by automatically extracting the permission information from the reception data which is received by the portable telephone 201.

In accordance with the above-explained arrangement, the security process operation based upon the environment of the communication counter terminal can be carried out before the data is transmitted to the communication counter terminal, and even if the data is not processed via the security process operation on the server, the safety characteristic of the data to the communication counter terminal can be grasped and assured on the transmission-sided terminal. More specifically, when a security process operation is carried out with respect to a large capacity of data, since a proper security process operation is selected in a higher efficiency, a time duration and a work load required in this proper security process operation can be considerably reduced. Also, since the security apparatus is mounted on the secure card, if there is such a communication terminal on which a security apparatus-mounted secure card can be mounted, then the present information transfer control apparatus can be constructed by replacing the secure card. Even when a transmission side owns a large number of various sorts of communication terminals, updating management as to security programs and pattern files of security apparatuses may be performed with respect to only one sheet of such a secure card. As a result, cumbersome security management can be largely reduced.

### Embodiment Mode 3

An embodiment mode 3 of the present invention is arranged as follows: That is, while the function of the security process operation provided in the portable telephone in the embodiment mode 1 is provided in a secure card as a data bridge medium, a necessary security process operation is carried out by the secure card itself with respect to data transmitted from the portable telephone.

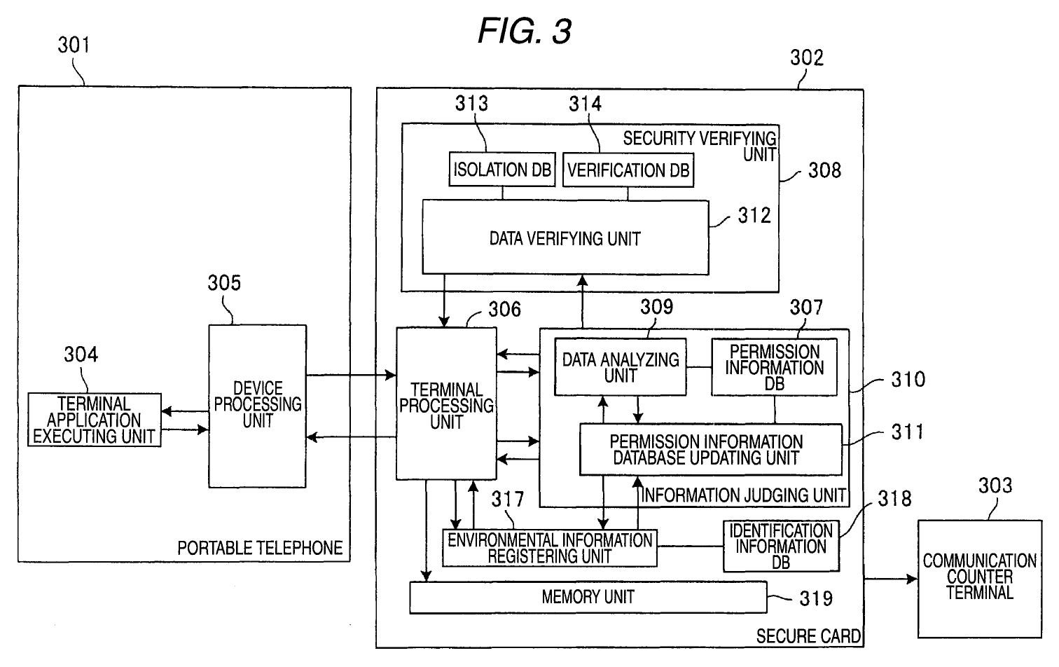

FIG. 3 is a block diagram for indicating an arrangement of an entire system as to an information transfer control apparatus according to an embodiment mode 3 of the present invention. As represented in FIG. 3, this system is equipped with a portable telephone 301, and a secure card 302 which is connectable with the portable telephone 101 and a communication counter terminal 303. In the embodiment mode 3 shown in FIG. 3, a portion of the structural elements of the portable telephone 101 of the embodiment mode 1 has been directly mounted on the secure card. While the secure card 302 is equipped with a smart card module, this secure card 302 is provided with a secure memory region which has been encrypted by the smart card module, and a normal memory region.

Although the above-explained portable telephone 301 is illustrated in FIG. 3 as one example of the communication terminal employed in this embodiment mode 3, any other electronic appliances may be employed if these electronic appliances own information communication functions capable of transferring information by being connected to a communication network, for example, a desk top PC, a notebook PC, a PDA, a PHS, a digital television, other information communication appliances, and information communication household appliances.

Also, the connecting mode of the secure card 302 is not limited only to such a detachable mounting type that the secure card 302 is detachably mounted on the portable telephone 301 via a card slot, but may be realized by various connecting types, for example, the secure card 302 may be connected via a USB interface, or a cable to a communication terminal.

Furthermore, an outer shape of the secure card 302 is not limited only to a card type, but may be freely modified. That is, the secure card 302 may be realized as a device which mounts thereon a CPU having an anti-dumper region.

The secure card 302 employed in the embodiment mode 3 of the present invention verifies transmission data which is tried to be written from the portable telephone 301 in response to an execution environment of the communication counter terminal 303 before this data is written in a memory unit 319.

Firstly, a description is made of an arrangement of the portable telephone 301. The portable telephone 301 is equipped with a terminal application executing unit 304, and a device processing unit 305. The terminal application executing unit 304 is operated on a terminal. The device processing unit 305 acquires transmission data from the terminal application executing unit 304, and transmits data to the secure card 302.

The above-explained secure card 302 is equipped with a terminal processing unit 306, an information judging unit 307, and a security verifying unit 308. The terminal processing unit 306 receives transmission data from the device processing unit 305. The information judging unit 307 determines a security process operation in response to an environment of the communication counter terminal 303. The security verifying unit 308 executes the determined security process operation. Also, the information judging unit 307 is equipped with a data analyzing unit 309, a permission information database 310, and a permission information database updating unit 311. The security verifying unit 308 is equipped with a data verifying unit 312, an isolation database 313, and a verification database 314. Also, the secure card 302 is provided with an environmental information registering unit 317 for acquiring environmental information, an identification information database 318 for storing thereinto the acquired environmental information, and a memory unit 319 for storing thereinto transmission data which is passed to the communication counter terminal 303.

In an actual case, a software module provided with the function as to the device processing unit 305 has been stored respectively in either a ROM or an EEPROM of the portable telephone 201, and then, since the CPU of the portable telephone 301 executes this software module, the function of the unit is realized. Also, the terminal application executing unit 304 is realized by the OS of the portable telephone 301 and a group of application programs operated on this OS.

In addition, software modules equipped with various functions as to the environmental information registering unit 317, the terminal processing unit 306, the data analyzing unit 309, the permission information database updating unit 311, and the data verifying unit 312 have been stored respectively in either a ROM or an EEPROM of an LSI chip provided in the secure card 302. These software modules are executed by a CPU of the secure card 302, so that the various functions are realized. Also, the identification information database 318, the permission information database 310, the isolation database 313, and the verification database 314 are stored in either a memory of the secure card 302 or a secure memory region which is encrypted by a smart card module, so that these functions are realized. Also, the memory unit 319 which stores thereinto the transmission data written from the portable telephone 301 is realized on either the memory or the secure memory region within the secure card 302. The respective software modules as to the terminal processing unit 306, the data analyzing unit 309, the permission information database updating unit 311, and the data verifying unit 312 access either the memory or the secure memory region of the secure card 302 so as to access the transmission data.

These structural elements other than the terminal processing unit 306 correspond to the structural elements contained in the portable telephone 101 of the embodiment mode 1. That is, the data analyzing unit 309 corresponds to the data analyzing unit 113; the permission information database 310 corresponds to the permission information database 114; the permission information database updating unit 311 corresponds to the permission information database updating unit 115; the data verifying unit 312 corresponds to the data verifying unit 116; the isolation database 313 corresponds to the isolation database 117; verification database 314 corresponds to the verification database 118; the environmental information registering unit 317 corresponds to the environmental information registering unit 106; and the identification information database 318 corresponds to the identification database 107; and the memory unit 319 corresponds to the memory provided in the portable table 101 and then, the respective units are operated in similar manners thereto.

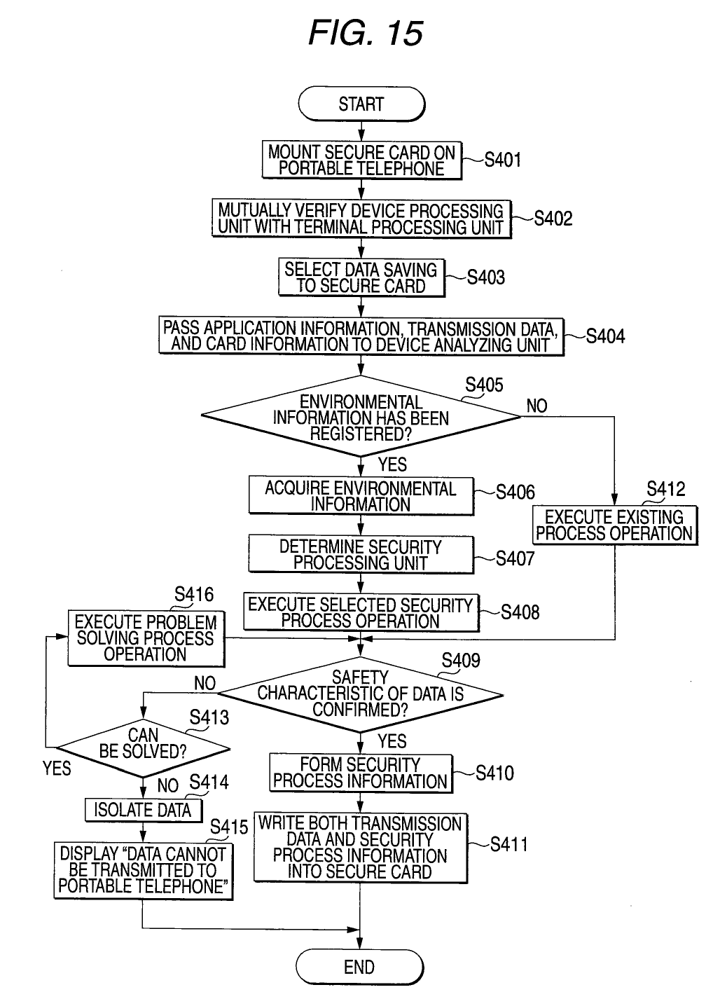

Referring now to a flow chart of FIG. 15, operations as to a communication terminal and a secure device will be described which are employed in this embodiment mode 3.

In the embodiment mode 3, the user mounts the secure card 302 on the portable telephone 301 (step S401). If the portable telephone 301 recognizes mounting of the secure card 302, then a mutual verification process operation is carried out between the device processing unit 305 and the terminal processing unit 306 in order that the device processing unit 305 recognizes that the mounted device corresponds to the secure card 302 on which the above-explained security apparatus is mounted (step S402).

Next, if the user initiates the application software by operating the terminal application executing unit 304 and selects saving of data to the secure card 302 by the terminal application executing unit 304 by operating the portable telephone 301 (step S403), then the terminal application executing unit 304 transmits both the transmission data and the application information via the device processing unit 305 to the secure card 302. On the side of the secure card 302, before the transmission data received from the portable telephone 301 is written in the memory unit 319 of the secure card 302, the terminal processing unit 306 passes both the transmission data and the application information to the data analyzing unit 309 in combination with the card identification information of the secure card 302 (step S404).

Thereafter, in a process operation of a step S411, process operations defined from a step S405 up to a step S416 are basically identical to the process operations defined from the step S7 up to the step S18 as explained in the flow chart of FIG. 5 except that the transmission data is not transmitted via the communication network 102, but is written in the memory unit 319 of the secure card 104. As a consequence, only such a data whose safety characteristic has been confirmed is written in the memory unit 319 of the secure card 302, whereas data whose safety characteristic has not been finally confirmed is not written in the secure card 302.

In this case, while the environmental information of the communication terminals owned by the card holders of the secure cards have been registered in the permission information data table 310, in the process operation for specifying the environmental information of the step S406, the data analyzing unit 309 specifies environmental information of the communication terminal owned by the card holder of the secure card 302. Also, in the process operation for selecting the security process operation based upon the environmental information of the step S407, the data analyzing unit 309 selects a security process operation based upon the environmental information of the communication terminal owned by the card holder of the secure card 309.

In accordance with the above-described arrangement, in such a case that data is written into a secure card connected to a first terminal (portable telephone 301), and this secure card is connected to a second terminal (communication counter terminal 303) so as to read out this data, a security process operation based upon a sort of the data and an execution environment of a terminal owned by the user who owns the second terminal is carried out by the secure card itself before the data is written into the memory of the secure card. Then, in the case that such a data containing an illegal program is tried to be saved, the secure card refuses saving of this data, and it is possible to avoid that the illegal program is executed in the second terminal.

As a consequence, in such a case that bridge media where data have been stored are executed by using various terminals, the security process operations with respect to the data are no longer carried out by the respective terminals. More specifically, when a security process operation is carried out with respect to a large capacity of data, a time duration and a work load required in the security process operation in each of the terminals can be considerably reduced. Also, since the security apparatus is mounted on the secure card, if there is such a communication terminal on which secure card can be mounted, then the present information transfer control apparatus can be constructed by replacing the secure card. Even when a transmission side owns a large number of various sorts of communication terminals, updating management as to security programs and pattern files of security apparatuses may be performed with respect to only one sheet of such a secure card. As a result, cumbersome security management can be largely reduced.

### Embodiment Mode 4

An embodiment mode 4 of the present invention is arranged as follows: That is, while the function of the security process operation in the portable telephone in the embodiment mode 1 is provided in a secure card as a data bridge medium, a necessary security process operation is carried out by a secure card itself with respect to data read out from the secure card.

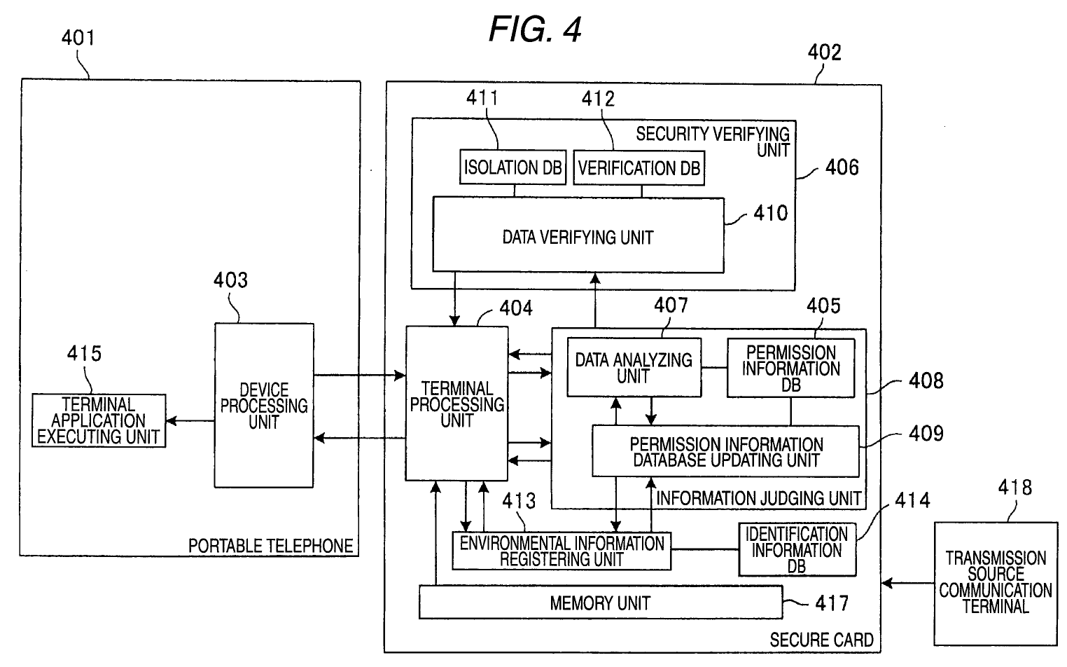

FIG. 4 is a block diagram for indicating an arrangement of an entire system as to an information transfer control apparatus according to an embodiment mode 4 of the present invention. As represented in FIG. 4, this system is equipped with a portable telephone 101, and a secure card 402 which is connectable with both the portable telephone 401 and a transmission source terminal 418. In the embodiment mode 4 represented in FIG. 4, a portion of the structural elements of the portable telephone 101 according to the embodiment mode 1 has been directly mounted on the secure card. While the secure card 402 is equipped with a smart card module, this secure card 402 is provided with a secure memory region which has been encrypted by the smart card module, and a normal memory region.

Although the above-explained portable telephone 401 is illustrated in FIG. 4 as one example of the communication terminal employed in this embodiment mode 4, any other electronic appliances may be employed if these electronic appliances own information communication functions capable of transferring information by being connected to a communication network, for example, a desk top PC, a notebook PC, a PDA, a PHS, a digital television, other information communication appliances, and information communication household appliances.

Also, the connecting mode of the secure card 402 is not limited only to such a detachable mounting type that the secure card 402 is detachably mounted on the portable telephone 401 and the terminal source terminal 418 via a card slot, but may be realized by various connecting types, for example, the secure card 402 may be connected via a USB interface, or a cable to a communication terminal.

Furthermore, an outer shape of the secure card 402 is not limited only to the card type, but may be freely modified. That is, the secure card 402 may be realized as a device which mounts thereon a CPU having an anti-dumper region.

The secure card 402 employed in the embodiment mode 4 of the present invention verifies transmission data which is written into a memory unit 417 of the secure card 402 by the transmission source terminal 418 in response to an execution environment of the portable telephone 401 before the portable telephone 401 reads out the transmission data from the memory unit 417.

Firstly, a description is made of an arrangement of the portable telephone 401. The portable telephone 401 is equipped with a terminal application executing unit 415, and a device processing unit 403. The terminal application executing unit 415 is operated on a terminal. The device processing unit 403 receives data from the secure card 402.

The above-explained secure card 402 is equipped with a terminal processing unit 404, an information judging unit 405, and a security verifying unit 406. The terminal processing unit 404 transmits data to the device processing unit 403. The information judging unit 405 determines a security process operation in response to an environment of the portable telephone 401. The security verifying unit 406 executes the determined security process operation. Also, the information judging unit 405 is equipped with a data analyzing unit 407, a permission information database 408, and a permission information database updating unit 409. The security verifying unit 406 is equipped with a data verifying unit 410, an isolation database 411, and a verification database 412. Also, the secure card 402 is provided with an environmental information registering unit 413 for acquiring environmental information, an identification information database 414 for storing thereinto the acquired environmental information, and a memory unit 417 which receives data from the transmission source terminal 418 and stores thereinto the received data.

In an actual case, a software module provided with the function as to the device processing unit 403 has been stored respectively in either a ROM or an EEPROM of the portable telephone 401, and then, since the CPU of the portable telephone 401 executes this software module, the function of the unit is realized. Also, the terminal application executing unit 415 is realized by the OS of the portable telephone 401 and a group of application programs operated on this OS.

In addition, software modules equipped with various functions as to the environmental information registering unit 413, the terminal processing unit 404, the data analyzing unit 407, the permission information database updating unit 409, and the data verifying unit 410 have been stored respectively in either a ROM or an EEPROM of an LSI chip provided in the secure card 402. These software modules are executed by a CPU of the secure card 402, so that the various functions are realized. Also, the identification information database 414, the permission information database 408, the isolation database 411, and the verification database 412 are stored in either a memory of the secure card 402 or a secure memory region which is encrypted by a smart card module, so that these functions are realized. Also, the memory unit 417 into which data is written from the transmission terminal 418 is realized on either the memory or the secure memory region within the secure card 402. The respective software modules as to the terminal processing unit 404, the data analyzing unit 407, the permission information database updating unit 409, and the data verifying unit 410 access either the memory or the secure memory region of the secure card 402 so as to access the transmission data.

These structural elements other than the terminal processing unit 404 correspond to the structural elements contained in the portable telephone 101 of the embodiment mode 1, which is similar to the above case of the embodiment mode 3. That is, the data analyzing unit 407 corresponds to the data analyzing unit 113; the permission information database 408 corresponds to the permission information database 114; the permission information database updating unit 409 corresponds to the permission information database updating unit 115; the data verifying unit 410 corresponds to the data verifying unit 116; the isolation database 411 corresponds to the isolation database 117; verification database 412 corresponds to the verification database 118; the environmental information registering unit 413 corresponds to the environmental information registering unit 106; and the identification information database 414 corresponds to the identification database 107; and the memory unit 417 corresponds to the memory provided in the portable table 101 and then, the respective units are operated in similar manners thereto.

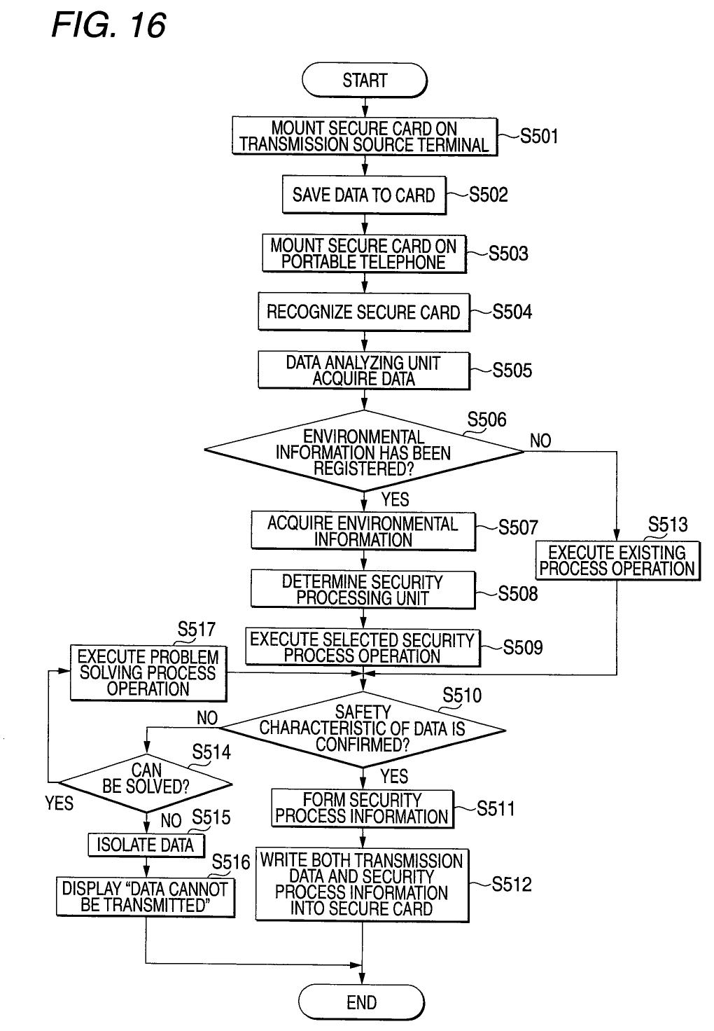

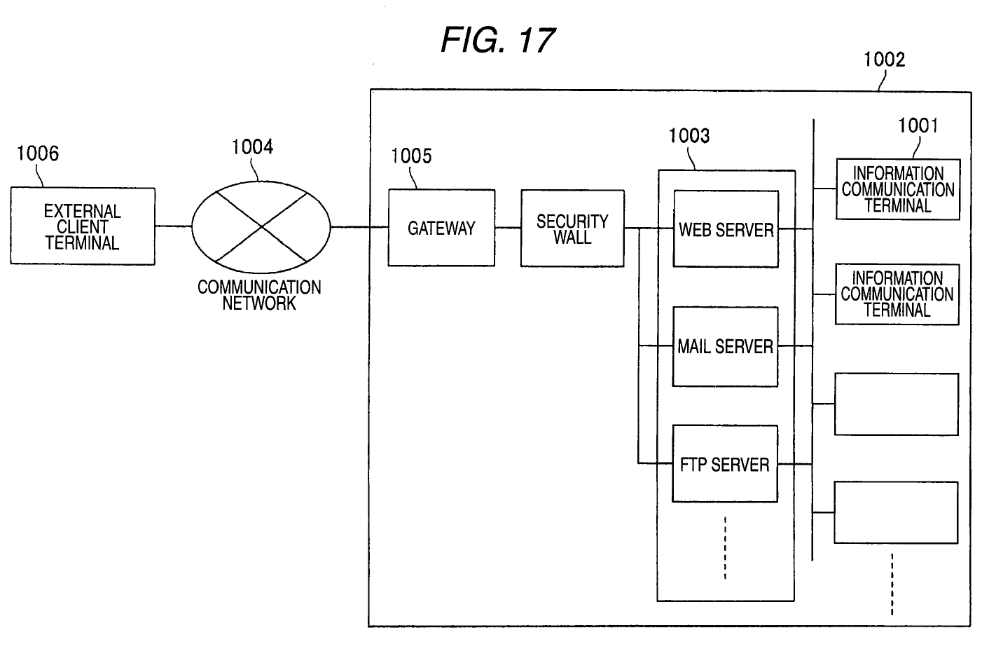

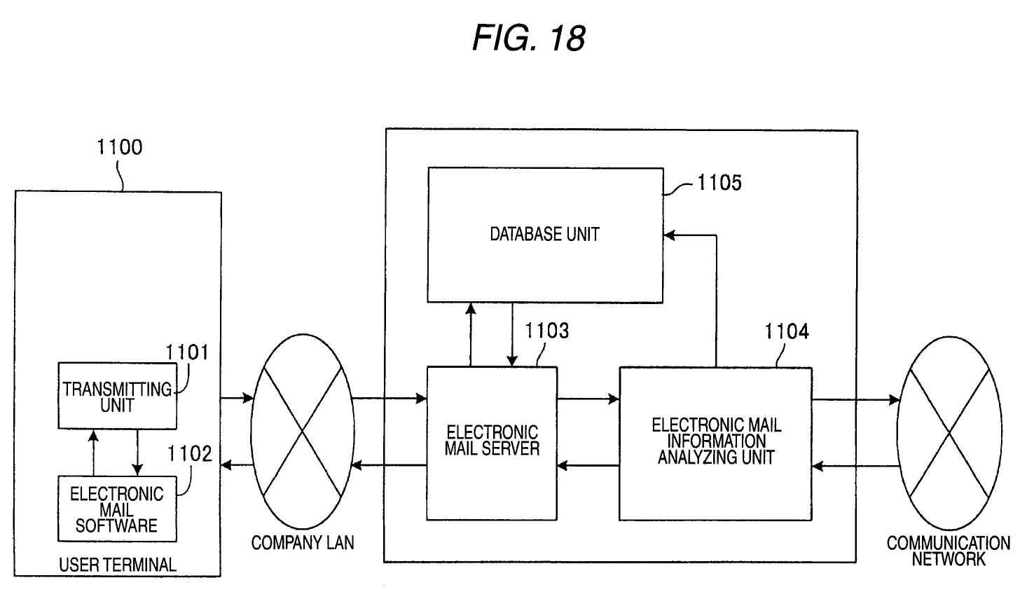

Referring now to a flow chart of FIG. 16, operations as to a communication terminal and a secure device will be described which are employed in this embodiment mode 4.

In this embodiment mode 4, if the secure card 402 is mounted on the transmission source terminal 418 (step S501) and saving of data to the secure card 402 is selected by operating the transmission source terminal 418, then both data and application information indicative of a sort of the above-explained data is saved in the memory unit 417 of the secure card 401 (step S502). The secure card 402 is passed to a user who owns the portable telephone 401, and then, the user mounts the secure card 402 on the portable telephone 401 (step S503). If the portable telephone 401 recognizes mounting of the secure card 402, then a mutual verification process operation is carried out between the device processing unit 403 and the terminal processing unit 404, the terminal processing unit 404 acquires the terminal identification information of the portable telephone 401, and then, the device processing unit 403 recognizes that the mounted device corresponds to the secure card 402 on which the above-explained security apparatus is mounted (step S504). Under such a condition that the portable telephone 401 recognizes the connection of the secure card 402, when the user operates the portable telephone 401 so as to read out data from the memory unit 417 of the secure card 402, the terminal application executing unit 415 transmits a data reading request via the device processing unit 403 to the secure card 402. On the side of the secure card 402, firstly, the terminal processing unit 404 reads out both the requested data and the requested application information thereof from the memory unit 417, and also, transmits both the read data and application information to the data analyzing unit 407 in combination with the terminal identification information of the portable telephone 401, and then, the data analyzing unit 407 acquires the data, the application information, and the card identification information of the secure card 402 (step S505).

Thereafter, in a process operation of a step S512, process operations defined from a step S506 up to a step S517 are basically identical to the process operations defined from the step S7 up to the step S18 as explained in the flow chart of FIG. 5 except that the required data is transmitted to the portable telephone 401, namely, reading of data by the portable telephone 401 is permitted. As a consequence, only such a data whose safety characteristic has been confirmed is read out from the memory unit 417 of the secure card 402, whereas data whose safety characteristic has not been finally confirmed is not read out from the secure card 402.

In accordance with the above-described arrangement, in such a case that data is written into a secure card connected to a first terminal (transmission source terminal 418), and this secure card is connected to a second terminal (portable telephone 401) so as to read out this data, a security process operation based upon a sort of the data and an execution environment of a terminal owned by the user who owns the second terminal is carried out by the secure card itself before the data is read out from the memory of the secure card. Then, in the case that such a data containing an illegal program is tried to be read out, the secure card refuses reading of this data from the second terminal, and it is possible to avoid that the illegal program is executed in the second terminal.

As a consequence, in such a case that bridge media where data have been stored are executed by using various terminals, the security process operations with respect to the data are no longer carried out by the respective terminals. More specifically, when a security process operation is carried out with respect to a large capacity of data, a time duration and a work load required in the security process operation in each of the terminals can be considerably reduced. Also, since the security apparatus is mounted on the secure card, if there is such a communication terminal on which secure card can be mounted, then the present information transfer control apparatus can be constructed by replacing the secure card. Even when a transmission side owns a large number of various sorts of communication terminals, updating management as to security programs and pattern files of security apparatuses may be performed with respect to only one sheet of such a secure card. As a result, cumbersome security management can be largely reduced.

While the present invention has been described in detail or with reference to specific embodiment modes, it is apparent for the ordinarily skilled engineer that the present invention may be modified and changed in various modes without departing from the technical spirit and scope of the present invention.

The present patent application is made based upon Japanese Patent Application (JP-2005-141486) filed on May 13, 2005, the contents of which are incorporated herein as references.

### INDUSTRIAL APPLICABILITY

As previously explained, the communication terminal, the secure device, and the integrated circuit, according to the present invention, can select and execute the security process operation in the higher efficiency in response to the communication counter terminal before the data is transmitted. As a result, the communication terminal, the secure device, and the integrated circuit can prevent the secondary infections in the case that the information communication terminal is infected by the virus, and can guarantee the safety characteristic of the data with respect to the communication counter terminal, and also, can increase the reliability with respect to the transmission data. Also, since the security process operation is mounted on one security device, as to the information communication terminal capable of mounting thereon this security device, the equivalent security apparatus can be constructed by merely mounting the security device, and there is an advantage as the system capable of reducing cumbersome security management when a large number of information communication terminals are utilized.

1-26. (canceled)

27. A communication terminal for transmitting data to a communication counter terminal via a network connected thereto, which is capable of transferring information, comprising:
a data analyzing unit for extracting identification information which identifies a communication counter terminal described in data which is transmitted, and for determining a predetermined verifying operation with respect to said data based upon said identification information in response to an execution environment of said communication counter terminal; and
a data verifying unit for executing the verifying operation determined by said data analyzing unit.

28. The communication terminal as claimed in claim 27 wherein:
said data analyzing unit is comprised of: a permission information database which has described therein execution environmental information of the communication counter terminal and a verifying operation executed by said data verifying unit in correspondence with said identification information; and
said data analyzing unit determines the verifying operation based upon said identification information by referring to said permission information database.

29. The communication terminal as claimed in claim 28 wherein:
a verifying operation which is executed by said data verifying unit is further described in said permission information database in correspondence with a sort of data to be transmitted; and said data analyzing unit determines a necessary verifying operation based upon said identification information and the sort of said data by referring to said permission information database.

30. The communication terminal as claimed in claim 28, wherein:
said data analyzing unit is further comprised of: a permission information database updating unit; and wherein:
said permission information database updating unit updates said permission information database based upon data received from the communication counter terminal.

31. The communication terminal as claimed in claim 30 wherein:
in the case that an execution environment of said communication counter terminal has been recorded in said permission information database, said permission information database updating unit compares execution environmental information of the communication counter terminal which is specified from the data received from the communication counter terminal with execution environmental information which has already been recorded in said permission information database; when the execution environmental information of the communication counter terminal is not coincident with said recorded execution environmental information, said permission information database updating unit updates said execution environmental information recorded in said permission information database by the execution environmental information of the communication counter terminal which is acquired from the data received from said communication counter terminal.

32. The communication terminal as claimed in claim 30 wherein:
in the case that the execution environmental information of said communication counter terminal is not described in said permission information database, said permission information database updating unit newly records the execution environmental information of the communication counter terminal which is specified from the data received from said communication counter terminal in said permission information database.

33. A secure device connectable with a communication terminal for transmitting data to a communication counter terminal via a network connected thereto, which is capable of transferring information, comprising:
a data analyzing unit for acquiring transmission data before being transmitted from said communication terminal, for extracting identification information which identifies said communication counter terminal described in said transmission data, and for determining a predetermined verifying operation with respect to said data based upon said identification information in response to an execution environment of said communication counter terminal; and
a data verifying unit for executing the verifying operation determined by said data analyzing unit.

34. The secure device as claimed in claim 33 wherein:
said data analyzing unit is further comprised of: a permission information database which has described therein execution environmental information of the communication counter terminal and a verifying operation executed by said data verifying unit in correspondence with said identification information; and
said data analyzing unit determines the verifying operation based upon said identification information by referring to said permission information database.

35. The secure device as claimed in claim 34 wherein:
a verifying operation which is executed by said data verifying unit is further described in said permission information database in correspondence with a sort of data which is transmitted by said communication terminal; and said data analyzing unit determines a necessary verifying operation based upon said identification information and the sort of said data by referring to said permission information database.

36. The secure device as claimed in claim 34, wherein:
said data analyzing unit is further comprised of: a permission information database updating unit; and wherein:
said permission information database updating unit updates said permission information database based upon data received from the communication counter terminal by said communication terminal.

37. The secure device as claimed in claim 36 wherein:
in the case that an execution environment of said communication counter terminal has been recorded in said permission information database, said permission information database updating unit compares execution environmental information of the communication counter terminal which is specified from the data received from the communication counter terminal by said communication terminal with execution environmental information which has already been recorded in said permission information database; when the execution environmental information of the communication counter terminal is not coincident with said recorded execution environmental information, said permission information database updating unit updates said execution environmental information recorded in said permission information database by the execution environmental information of the communication counter terminal which is acquired from the data received from said communication counter terminal.

38. The secure device as claimed in claim 36 wherein:
in the case that the execution environmental information of said communication counter terminal is not described in said permission information database, said permission information database updating unit newly records the execution environmental information of the communication counter terminal which is specified from the data received from said communication counter terminal in said permission information database.

39. The communication terminal on which the secure device recited in claim can be mounted, comprising:
a device processing unit for judging as to whether or not said secure device is mounted; and
an information processing unit operated in such a manner that when said device processing unit judges that said secure device is mounted, before data is transmitted from said communication terminal, said information processing unit transmits said data to said secure device.

40. A communication terminal for transmitting data with respect to a secure device mounted on said communication terminal, comprising:
a device processing unit for acquiring identification information from said secure device when said secure device is mounted, said identification information identifying a owner of said secure device;
a data analyzing unit for determining a predetermined verifying operation with respect to said data based upon said identification information in response to an execution environment of an appliance where said secure device is used; and
a data verifying unit for executing the verifying operation determined by said data analyzing unit.

41. The communication terminal as claimed in claim 40 wherein:
said data analyzing unit is comprised of: a permission information database which has described therein execution environmental information of the appliance where said secure device is utilized and a verifying operation executed by said data verifying unit in correspondence with said identification information; and
said data analyzing unit determines the verifying operation based upon said identification information by referring to said permission information database.

42. The communication terminal as claimed in claim 41 wherein:
a verifying operation which is executed by said data verifying unit is further described in said permission information database in correspondence with a sort of data which is transmitted by said communication terminal; and said data analyzing unit determines a necessary verifying operation based upon said identification information and the sort of said data by referring to said permission information database.

43. The communication terminal as claimed in claim 40, wherein:
when data is transmitted to said secure device, said data analyzing unit further determines a predetermined verifying operation based upon said identification information in response to an execution environment of the secure device; and
said data verifying unit executes said verifying operation determined by said data analyzing unit.

44. A secure device which is connected to a first terminal so as to write thereinto data, and connected to a second terminal so as to read said data, whereby said secure device transmits and receives data between said first and second terminals, comprising:
a memory unit for storing thereinto said data;
a data analyzing unit for determining a predetermined verifying operation with respect to said data in response to an execution environment of said second terminal; and
a data verifying unit for executing the verifying operation determined by said data analyzing unit; wherein:
before the data received from said first terminal is stored in said memory unit, said data analyzing unit determines the verifying operation, and said data verifying unit verifies said data.

45. The secure device as claimed in claim 44 wherein:
said data analyzing unit is comprised of: a permission information database which has described therein a verifying operation executed by said data verifying unit in correspondence with identification information of a terminal; and
said data analyzing unit determines the verifying operation based upon said identification information of the second terminal by referring to said permission information database.

46. The secure device as claimed in claim 45 wherein:
a verifying operation which is executed by said data verifying unit is further described in said permission information database in correspondence with a sort of data which is transmitted by said communication terminal; and said data analyzing unit determines a necessary verifying operation based upon said identification information and the sort of said data by referring to said permission information database.

47. A secure device which is connected to a first terminal so as to write thereinto data, and connected to a second terminal so as to read said data, whereby said secure device transmits and receives data between said first and second terminals, comprising:
a memory unit for storing thereinto said data;
a data analyzing unit for determining a predetermined verifying operation with respect to said data in response to an execution environment of said second terminal; and
a data verifying unit for executing the verifying operation determined by said data analyzing unit; wherein:
before the data stored in said memory unit is transmitted to the second terminal during reading operation, said data analyzing unit determines the verifying operation, and said data verifying unit verifies said data.

48. The secure device as claimed in claim 47 wherein:
said data analyzing unit is comprised of: a permission information database which has described therein a verifying operation executed by said data verifying unit in correspondence with identification information of a terminal; and
said data analyzing unit determines the verifying operation based upon said identification information of the second terminal by referring to said permission information database.

49. The secure device as claimed in claim 48 wherein:
a verifying operation which is executed by said data verifying unit is further described in said permission information database in correspondence with a sort of data which is transmitted by said communication terminal; and said data analyzing unit determines a necessary verifying operation based upon said identification information and the sort of said data by referring to said permission information database.
